(19) United States
(12) Patent Application Publication
(10) Pub. No.: US 2012/0184312 A1
(43) Pub. Date: Jul. 19, 2012

(54) BASE STATION DEVICE

(75) Inventors: Takashi Yamamoto, Osaka-shi (JP); Kenichi Murakami, Osaka-shi (JP); Yoshiyuki Shimada, Osaka-shi (JP)

(73) Assignee: Sumitomo Electric Industries, Ltd., Osaka-shi, Osaka (JP)

(21) Appl. No.: 13/498,762

(22) PCT Filed: Oct. 7, 2010
(86) PCT No.: PCT/JP2010/067628

§ 371 Date: Mar. 28, 2012

(30) Foreign Application Priority Data
Oct. 7, 2009 (JP) 2009-233886

(51) Int. Cl. H04B 15/00; H04W 72/04; H04W 4/00

(52) U.S. Cl. 455/502; 455/524; 455/509

(57) ABSTRACT

A base station device includes: a downlink signal reception unit 12 that receives a transmission signal from another base station device; a synchronization processing unit 5b that obtains the transmission signal received by the downlink signal reception unit 12, and performs a synchronization process by using the transmission signal; and a terminal detection unit 5e that detects the state of communication with terminal devices connected to the base station device and/or the another base station device. The synchronization processing unit 5b adjusts the timing to obtain the transmission signal, based on a detection result of the terminal detection unit 5e.

### TECHNICAL FIELD

The present invention relates to a base station device that performs wireless communication with terminal devices.

### BACKGROUND ART

A number of base station devices, each performing wireless communication with terminal devices, are provided so as to cover a wide area. At this time, inter-base-station synchronization may be performed, in which synchronization of timings of communication frames or the like is achieved among a plurality of base station devices.

For example, Patent Literature 1 discloses inter-base-station synchronization using a transmission signal from another base station device serving as synchronization source.

### CITATION LIST

### Patent Literature

[PTL 1] Japanese Laid-Open Patent Publication No. 2009-177532

### SUMMARY OF THE INVENTION

### Problems to be Solved by the Invention

Even if inter-base-station synchronization has been achieved at one time between a plurality of base station devices, the base station devices might be out of synchronization while the base station devices are operating. For example, when the plurality of base station devices have different clock accuracies, even if synchronization of communication frame timings or communication frequencies has been achieved at one time among the base station devices, synchronization error occurs again as time passes.

In order to solve such a problem, synchronization may be performed periodically. Thereby, even when synchronization error occurs with the passage of time, since synchronization is periodically performed, the inter-base-station synchronization can be mostly maintained.

When a base station device attempts to achieve synchronization with another base station device, the base station device needs to receive a transmission signal that is transmitted from the another base station device to a terminal device. Therefore, during the reception, the base station device cannot perform transmission/reception with a terminal device, which might cause significant influence on the quality of communication with the terminal device.

Accordingly, if inter-base-station synchronization is frequently performed, the synchronization accuracy is improved, but the base station device frequently receives the transmission signal from the another base station device. In this case, the quality of essential communication performed between the base station device and the terminal device is degraded. On the other hand, if the frequency of inter-base-station synchronization is reduced, reduction in the quality of communication with the terminal device is suppressed, but the synchronization accuracy might be reduced.

In order to solve the above problem, the process of inter-base-station synchronization may be performed in a constant cycle by which the communication quality and the synchronization accuracy are balanced. In this case, however, the synchronization process is periodically performed even when the communication state between the base station device and the terminal device varies and thereby the necessity of the synchronization process is reduced, that is, the less necessary process is performed at relatively high frequency, resulting in waste.

Further, the above-mentioned situation occurs, not only in the case where inter-base-station synchronization is performed, but commonly in processes associated with periodical reception of a transmission signal from another base station device.

The base station devices are roughly classified into: macro base stations (transmission power=about 2 W to 40 W) each forming a macro cell having a size of about 500 m or larger; and small base stations (transmission power=2 W or less) each forming a relatively small cell (smaller than about 500 m). The “cell” means an area in which a base station device is communicable with a terminal device.

Examples of small base stations include: a pico base station that has a transmission power of about 200 mW to 2 W, and forms a pico cell having a size of about 100 m to 500 m; and a femto base station that has a transmission power of about 20 mW to 200 mW, and forms a femto cell having a size of 100 m or smaller.

Since a femto cell formed by a femto base station device is usually located in a macro cell, almost the entire area of the femto cell may overlap with the macro cell. Moreover, a femto base station device may be installed in an arbitrary position in a macro cell by a user.

Therefore, a downlink signal from a femto base station device may interfere with a terminal device connected to a macro base station device, or an uplink signal transmitted from a terminal device connected to a femto base station device may interfere with a macro base station device.

Further, a plurality of femto base station devices that form neighboring femto cells and terminal devices connected to the femto base station devices may interfere with each other.

In order to avoid such interference, it is considered that a resource used by a macro base station device and a resource used by a femto base station device are adjusted and allocated so as not to overlap with each other in the frequency direction or the time direction.

In order to adjust and allocate the resources of these base station devices so as not to overlap with each other, it is essential that the radio frames of the base station devices should be accurately synchronized with each other.

Accordingly, when there is a possibility that interference may occur due to the relationship between a base station device and another base station device serving as a synchronization source, it is preferable that inter-base-station synchronization should be achieved with higher accuracy.

Therefore, an object of the present invention is to provide a base station device that can appropriately perform a process associated with obtaining a transmission signal from another base station device.

Another object of the present invention is to provide a base station device that can perform a synchronization process so as to favorably avoid interference, even when interference is likely to occur due to the relationship between the base station device and another base station device as a synchronization source in inter-base-station synchronization.

### Solution to the Problems

(1) A base station device according to the present invention includes: a reception unit that receives a transmission signal from another base station device; a processing unit that obtains the transmission signal from the reception unit, and performs a process with respect to the transmission signal; and a detection unit that detects the state of communication with terminal devices connected to the base station device and/or the another base station device. The processing unit adjusts the timing to obtain the transmission signal, based on a detection result of the detection unit.

According to the base station device of the above-mentioned configuration, the processing unit adjusts the timing to obtain a transmission signal, based on the state of communication with terminal devices connected to the base station device and/or the another base station device. Therefore, for example, the processing unit can perform the process at a timing according to the necessity of the process, which necessity varies depending on the state of communication with the terminal devices. As a result, the processing unit can appropriately perform a process associated with reception of a transmission signal from another base station device.

(2) If the process associated with reception of a transmission signal from another base station device is periodically required, it is preferable that the processing unit adjusts the timing so that the process is periodically performed. Further, a control unit may adjust the cycle of the process based on the detection result of the detection unit.

(3) The communication state of a terminal device connected to another base station device can be grasped by confirming whether a signal directed to the terminal is included in a downlink signal (transmission signal) from the another base station device. Accordingly, the detection unit can measure a reception power (reception level) of the downlink signal received from the another base station device, and detect, based on the reception power, the state of communication with the terminal device connected to the another base station device.

(4) Further, the detection unit may measure the reception power of the downlink signal from the another base station device, for each of minimum units of resource allocation in the downlink signal from the another base station device. In this case, presence/absence of a signal directed to the terminal device can be grasped for each minimum unit, and thereby the communication state of the terminal device can be detected more precisely.

(5) Note that the communication state detected by the detection unit is, specifically, the number of terminal devices connected to the base station device and/or the another base station device.

(6), (9) Specifically, the processing unit may include a synchronization processing unit that performs a synchronization process for achieving inter-base-station synchronization with the another base station device, based on the transmission signal, or may include a measurement processing unit that performs a measurement process for measuring the transmission signal.

In this case, the processing unit can adjust the timing of the process so that the synchronization accuracy and the like are maintained while suppressing influence on the essential communication.

(7), (8) When the processing unit includes the synchronization processing unit, it is preferable that the synchronization processing unit adjusts the cycle of the synchronization process to be longer as the number of terminal devices connected to the base station device decreases, and adjusts the cycle of the synchronization process to be longer as the number of terminal devices connected to the another base station device decreases.

In this case, if the necessity of the synchronization process is low because the number of terminal devices connected to the base station device or the number of terminal devices connected to the another base station device is small, the frequency of the synchronization process may be reduced. As a result, the processing unit can efficiently perform the synchronization process.

(10) Note that the detection unit can detect the communication state by using a measurement result by the measurement processing unit. In this case, the detection unit need not have a configuration for obtaining information relating to a transmission signal from another base station device, the structure of the detection unit is simplified.

(11) A base station device according to the present invention includes: a reception unit that receives a transmission signal from another base station device; and a processing unit that obtains the transmission signal from the reception unit, and performs, based on the transmission signal, a synchronization process for achieving inter-base-station synchronization. The processing unit adjusts the timing to perform the synchronization process, based on information indicating whether interference can occur due to the relationship between the base station device and the another base station device.

According to the base station device of the above-mentioned configuration, the processing unit adjusts the timing to perform the synchronization process, based on the information indicating whether interference can occur due to the relationship between the base station device and the another base station device. Therefore, for example, when it is determined that interference can occur due to the relationship with the another base station device, the frequency of the synchronization process can be increased to effectively suppress such interference, thereby enhancing the accuracy of the inter-base-station synchronization. As a result, even when there is a possibility that interference may occur due to the relationship with the another base station device as a synchronization source, the processing unit can perform the synchronization process so as to favorably avoid such interference.

(12) More specifically, the information indicating whether interference can occur due to the relationship between the base station device and the another base station device is, preferably, the number of terminal devices connected to the base station device and/or the another base station device.

(13) Further, the closer the position of another base station device is to the base station device, the higher the possibility that the transmission signals from the base station device and the another base station device interfere with the terminal devices connected to these base station devices, respectively. Thus, depending on the positional relationship between the base station device and the another base station device, it is preferable that the accuracy of inter-base-station synchronization between these base station devices should be high in order to effectively suppress such interference.

Accordingly, the information indicating whether interference can occur due to the relationship between the base station device and the another base station device is, preferably, information indicating the positional relationship between the base station device and the another base station device, or information whose value is influenced by the positional relationship between the base station device and the another base station device.

In this case, the processing unit adjusts the timing to perform the synchronization process, based on the information indicating the positional relationship between the base station device and the another base station device, or the information whose value is influenced by the positional relationship between the base station device and the another base station device. Accordingly, for example, when it is determined, based on the above-mentioned information, that the base station device and the another base station device 1 are relatively close to each other and the possibility that interference may occur is high, the processing unit can adjust the timing of the synchronization process so as to increase the frequency of the synchronization process. As a result, the accuracy of the inter-base-station synchronization is enhanced, and interference that may occur between the base station device and the another base station device can be effectively suppressed.

On the other hand, when it is determined, based on the above-mentioned information, that the base station device and the another base station device are relatively far from each other and the possibility that interference may occur is low, the processing unit can adjust the timing of the synchronization process so that the frequency of the synchronization process becomes higher than in the case where it is determined that the possibility of occurrence of interference is high. As a result, the synchronization process is avoided from being performed in vain.

As described above, according to the base station device, the processing unit adjusts the timing to perform the synchronization process based on, for example, the information indicating the positional relationship between the base station device and the another base station device. Therefore, even when there is a possibility that interference may occur due to the relationship with the another base station device serving as a synchronization source in inter-base-station synchronization, the processing unit can perform the synchronization process so as to favorably avoid such interference.

(14) More specifically, the information whose value is influenced by the positional relationship between the base station device and the another base station device is, preferably, information relating to a detection result obtained when a transmission signal from the another base station device is detected, or a reception level of the transmission signal from the another base station device, or a path-loss value between the base station device and the another base station device.

(15), (16) The information relating to a detection result obtained when a transmission signal from the another base station device is detected is, preferably, the number of times the another base station device is detected within a predetermined time period, or a detection rate that is a ratio of the number of times the another base station device is detected, to the number of times the detection is executed.

Alternatively, the information relating to a detection result obtained when a transmission signal from the another base station device is detected may be the time at which the transmission signal from the another base station device has been detected most recently, or the elapsed time from the time at which the downlink signal from the another base station device has been detected most recently to the present time.

(17) Further, in the base station device of the above section (13), the information whose value is influenced by the positional relationship between the base station device and the another base station device is, preferably, information relating to the number of trials of handover by a terminal device connected to the base station device or the another base station device, the handover being performed between the base station device and the another base station device, or information whose value is influenced by the number of trials of handover.

The larger the number of trials of handover, the higher the possibility that the another base station device is located near the base station device. Therefore, if the number of trials of handover is relatively large, the possibility that interference may occur between the base station device and the another base station device is high.

That is, the number of trials of handover is information indicating the positional relationship between the base station device and the another base station device, or information whose value is influenced by the positional relationship between the base station device and the another base station device, or information.

Accordingly, also in the case, since the processing unit adjusts the timing to perform the synchronization process based on the number of trials of handover, even when there is a possibility that interference may occur due to the relationship with the another base station device serving as a synchronization source in inter-base-station synchronization, the processing unit can perform the synchronization process so as to favorably avoid such interference.

(18) If the carrier wave frequency of the another base station device is the same as that of the base station device, the possibility that the downlink signals from these base station devices interfere with the terminal devices connected to these base station devices, respectively, increases.

Further, the larger the number of terminal devices that are located near the base station device and connected to the another base station device, the higher the possibility that the base station device interferes with the terminal devices connected to the another base station device.

If the another base station device is a macro base station, the possibility that more terminal devices are connected to the another base station device is high as compared to the case where the another base station device is a femto base station. Accordingly, the possibility of occurrence of interference is higher in the case where the another base station device is a macro base station device than in the case where it is a femto base station.

Moreover, an access mode defines restriction on access of terminal devices to a base station device, and indicates the public nature of the base station device. For example, when a base station device is in a mode in which the degree of restriction on access of terminal devices to the base station device is low, the base station device is highly public, and many terminal devices are highly likely to be connected to the base station device. Accordingly, the lower the degree of restriction on access of terminal devices to a base station device, the higher the possibility that the base station device may cause interference.

Accordingly, the information indicating whether interference can occur due to the relationship between the base station device and the another base station device is, preferably, information indicating a carrier wave frequency of the another base station device, information that allows identification as to whether the another base station device is a macro base station or a femto base station, information indicating a transmission power of the transmission signal, information indicating an access mode of the another base station device to a terminal device connected to the another base station device, or the estimated number of terminal devices that are located near the base station device and are connected to the another base station device.

(19), (20) The processing unit may adjust the timing to perform the synchronization process, based on, in addition to the information indicating whether interference can occur due to the relationship between the base station device and the another base station device, information indicating whether the interference is avoidable. In this case, it is possible to favorably avoid interference between the base station device and the another base station device that is likely to cause interference.

More specifically, the information indicating whether the interference is avoidable is, preferably, information indicating a resource block allocation scheme adopted when the another base station device performs resource allocation to the terminal device connected to the another base station device, or information indicating whether inter-base-station communication is possible between the base station device and the another base station device.

(21) A base station device according to the present invention includes: a reception unit that receives a transmission signal from another base station device; and a processing unit that obtains the transmission signal from the reception unit, and performs, based on the transmission signal, a synchronization process for achieving inter-base-station synchronization. The processing unit adjusts the timing to perform the synchronization process, based on information indicating a reception accuracy of a transmission signal from the another base station device, or information whose value influences the reception accuracy of the transmission signal from the another base station device.

In this case, if the reception accuracy of the transmission signal from the another base station device is high to the extent that allows highly accurate inter-base-station synchronization, the synchronization accuracy can be maintained high without increasing the frequency of the synchronization process. As a result, the processing unit can perform the synchronization process so as to favorably avoid interference.

(22) The information indicating a reception accuracy of a transmission signal from the another base station device is preferably a reception level at which the transmission signal is received, or an SINR.

(23) Further, the closer the another base station device is to the base station device, the higher the reception accuracy of the transmission signal from the another base station device. That is, the positional relationship between the base station device and the another base station device influences the reception accuracy of the transmission signal from the another base station device.

Accordingly, the information whose value influences the reception accuracy of a transmission signal from the another base station device is, preferably, information indicating the positional relationship between the base station device and the another base station device, or information whose value is influenced by the positional relationship between the base station device and the another base station device.

In this case, the processing unit adjusts the timing to perform the synchronization process, based on the information indicating the positional relationship between the base station device and the another base station device, or the information whose value is influenced by the positional relationship between the base station device and the another base station device. Accordingly, for example, when it is determined, based on the above-mentioned information, that the base station device and the another base station device are close to each other and the reception accuracy of the transmission signal from the another base station device is high to the extent that allows highly accurate inter-base-station synchronization, the accuracy of the inter-base-station synchronization can be maintained high without increasing the frequency of the synchronization process. Therefore, the processing unit can adjust the timing of the synchronization process so that the frequency of the synchronization process becomes relatively low. As a result, the accuracy of the inter-base-station synchronization can be maintained high without performing the synchronization process in vain, and interference that may occur between the base station device and the another base station device can be effectively suppressed.

On the other hand, when it is determined, based on the above-mentioned information, that the base station device and the another base station device are relatively far from each other and the reception accuracy of the transmission signal from the another base station device is relatively low, the processing unit can adjust the timing of the synchronization process so that the frequency of the synchronization process becomes higher than in the case where it is determined that the reception accuracy is high. As a result, the accuracy of the inter-base-station synchronization is enhanced, and interference that may occur between the base station device and the another base station device can be effectively suppressed.

As described above, according to the base station device, since the processing unit adjusts the timing to perform the synchronization process based on, for example, the information indicating the positional relationship between the base station device and the another base station device, which is information that influences the reception accuracy of the transmission signal from the another base station device, the processing unit can perform the synchronization process so as to favorably avoid interference.

(24) More specifically, the information whose value is influenced by the positional relationship between the base station device and the another base station device is preferably information relating to a detection result obtained when the transmission signal from the another base station device is detected.

(25), (26) The information relating to a detection result obtained when the transmission signal from the another base station device is detected is, preferably, the number of times the another base station device is detected within a predetermined period, or a detection rate that is a ratio of the number of times the another base station device is detected, to the number of times the detection is executed.

Further, the information relating to a detection result obtained when the transmission signal from the another base station device is detected may be the time at which the transmission signal from the another base station device has been detected most recently, or the elapsed time from the time at which the downlink signal from the another base station device has been detected most recently to the present time.

(27) Further, in the base station device of the above section (23), the information whose value is influenced by the positional relationship between the base station device and the another base station device is, preferably, information relating to the number of trials of handover by a terminal device connected to the base station device or the another base station device, the handover being performed between the base station device and the another base station device, or information whose value is influenced by the number of trials of handover.

### Advantageous Effects of the Invention

According to the base station device of the present invention, it is possible to appropriately perform the process associated with reception of a transmission signal from another base station device.

Further, according to the base station device of the present invention, even when there is a possibility that interference may occur due to the relationship between the base station device and another base station device serving as a synchronization source in inter-base-station synchronization, it is possible to perform the synchronization process so as to favorably avoid such interference.

### BRIEF DESCRIPTION OF THE DRAWINGS

FIG. 1 is a schematic diagram showing a configuration of a wireless communication system according to a first embodiment of the present invention.

FIG. 2 is a diagram showing structures of uplink and downlink radio frames for LTE.

FIG. 3 is a diagram showing a structure of a DL frame in detail.

FIG. 4 is a block diagram showing a configuration of a femto base station.

FIG. 5 is a block diagram showing an RF unit in detail.

FIG. 6 is a block diagram showing a configuration of a synchronization processing unit that performs a synchronization process for achieving inter-base-station synchronization with another base station device.

FIG. 7 is a diagram for explaining an example of a synchronization process the synchronization processing unit performs.

FIG. 8 is a diagram for explaining an example of a measurement process a measurement processing unit performs.

FIG. 9 is a diagram showing an example of average power values for respective resource blocks, which are determined by the measurement processing unit.

FIG. 10 is a diagram showing timings at which the synchronization process and the measurement process are performed.

FIG. 11 is a flowchart showing a manner of adjusting the cycle of the synchronization process, which is performed by the synchronization processing unit.

FIG. 12 is a partial block diagram showing a part of the internal configuration of a femto base station according to a second embodiment of the present invention.

FIG. 13 is a diagram showing an example of an arrangement of the femto base station according to the second embodiment in a wireless communication system.

FIG. 14 is a diagram showing a manner of connection of respective BSs to a communication network.

FIG. 15 is a sequential diagram showing an example of process steps when the femto base station device of the second embodiment obtains measurement result information.

FIG. 16 is a diagram showing an example of neighboring cell information stored in the femto base station device.

FIG. 17(a) is a diagram showing an example of a detection result of other base station devices detected when a femto base station device according to a second modification of the second embodiment obtains measurement result information, and FIG. 17(b) is a diagram showing an example of neighboring cell information generated by a neighboring cell information generation unit according to the second modification, based on the detection result shown in FIG. 17(a).

FIG. 18(a) is a diagram showing an example of a detection result of other base station devices detected when a femto base station device according to a second modification of the second embodiment obtains measurement result information, and FIG. 18(b) is a diagram showing an example of neighboring cell information generated by a neighboring cell information generation unit of this modification, based on the detection result shown in FIG. 18(a).

FIG. 19 is a partial block diagram showing a part of an internal configuration of a femto base station device according to a third embodiment of the present invention.

FIG. 20 is a sequential diagram showing an example of a manner in which the femto base station device according to the third embodiment obtains handover information during handover performed with a terminal device.

FIG. 21 is a diagram showing an example of a manner in which the femto base station device updates the neighboring cell information when handover has been performed in the procedure shown in FIG. 20.

FIG. 22 is a diagram showing another example of a manner in which the femto base station device updates the neighboring cell information when handover has been performed.

FIG. 23 is a partial block diagram showing a part of an internal configuration of a femto base station device according to a fourth embodiment of the present invention.

FIG. 24 is a diagram showing access modes in which base station devices are set.

FIG. 25 is a diagram showing an example of neighboring cell information generated by the femto base station device according to the fourth embodiment.

FIG. 26 is a partial block diagram showing a part of an internal configuration of a femto base station device according to a fifth embodiment of the present invention.

FIG. 27 is a diagram showing an example of neighboring cell information generated by the femto base station device of the fifth embodiment.

FIG. 28 is a partial block diagram showing a part of an internal configuration of a femto base station device according to a sixth embodiment of the present invention.

FIG. 29 is a flowchart showing a method for estimating the number of terminal devices that are located near the base station device and are connected to another base station device.

FIG. 30 is a diagram showing an example of a case where a first PRACH and a second PRACH are set on a UL frame.

### DESCRIPTION OF EMBODIMENTS

Preferred embodiments of the present invention will be described below with reference to the accompanying drawings.

### 1. First Embodiment

[Configuration of Communication System]

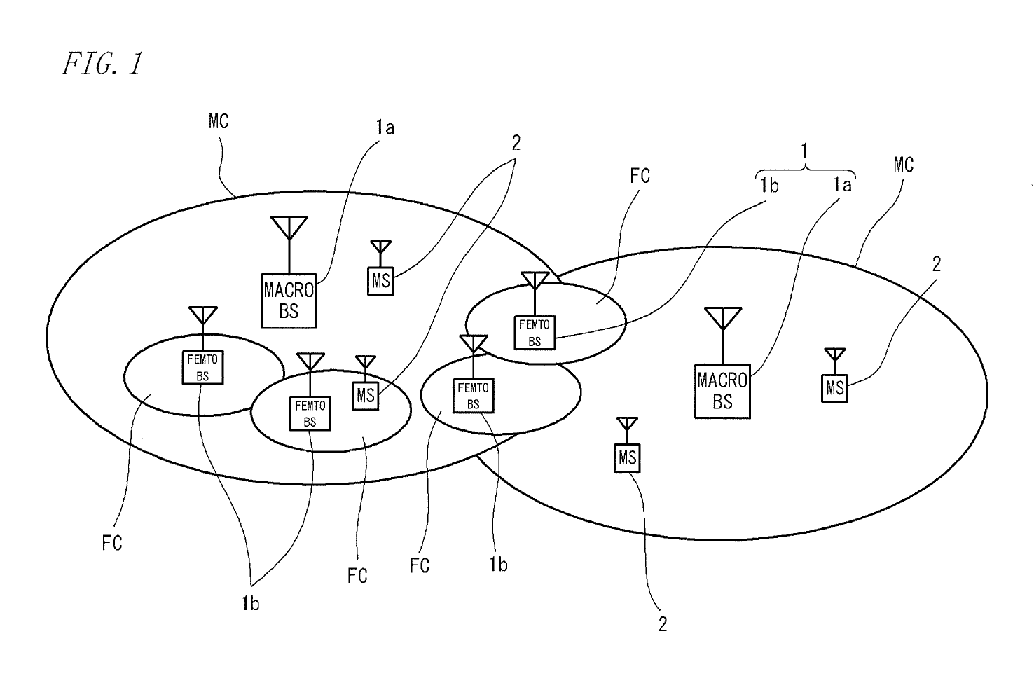

FIG. 1 is a schematic diagram showing a configuration of a wireless communication system according to an embodiment of the present invention.

This wireless communication system includes a plurality of base station devices 1, and a plurality of terminal devices 2 (mobile stations) that are allowed to perform wireless communication with the base station devices 1.

The plurality of base station devices 1 include: for example, a plurality of macro base stations 1a each forming a communication area (macro cell) MC having a size of several kilometers; and a plurality of femto base stations 1b each forming a relatively small femto cell FC having a size of several tens of meters, and being located in the macro cells MC.

Each macro base station device 1a (hereinafter, also referred to as “macro BS 1a”) is allowed to perform wireless communication with a terminal device 2 existing in its own macro cell MC.

On the other hand, each femto base station device 1b (hereinafter, also referred to as “femto BS 1b”) is installed in a place, such as a house, where a radio wave from the macro BS 1a is hardly received, and forms a femto cell FC. Each femto BS 1b is allowed to perform wireless communication with a terminal device 2 (hereinafter, also referred to as “MS 2”) existing in its own femto cell FC. In the system, even in a place where a radio wave from the macro BS 1a is hardly received, it is possible to provide the MS 2 with a service with a sufficient throughput by installing the femto BS 1b that forms a relatively small femto cell FC in the place.

In the above-mentioned wireless communication system, after installation of a macro BS 1a, a femto BS 1b is installed in a macro cell MC formed by the macro BS 1a, and then forms a femto cell FC in the macro cell MC. Therefore, the femto BS 1b might cause interference or the like with the macro BS 1a or with an MS 2 or the like that communicates with the macro BS 1a.

Therefore, the femto BS 1b has a function of performing monitoring (measurement process) of the transmission status such as the transmission power and the operating frequency of another base station device 1 such as a macro BS 1a or a femto BS 1b other than itself, and a function of adjusting, based on the monitoring result, the transmission state such as the transmission power and the operating frequency so as not to affect communication in the macro cell MC. These functions allow the femto BS 1b to form the femto cell FC in the macro cell MC without affecting communication of the another base station device.

Further, in the communication system of the present embodiment, inter-base-station synchronization is performed, in which synchronization of communication frame timings is achieved among the plurality of base station devices including the macro BSs 1a and the femto BSs 1b.

The inter-base-station synchronization is executed by “over-the-air synchronization” in which a signal transmitted by a base station device serving as a master (synchronization source) to an MS 2 existing in its own cell, is received by another base station device, thereby achieving synchronization.

The base station device serving as a master (synchronization source) may achieve over-the-air synchronization with still another base station device 1, or may determine a frame timing by any other method than over-the-air synchronization, such as autonomously determining a frame timing by using a GPS signal.

However, a macro BS 1a can select another macro BS 1a as a master, but cannot select a femto BS 1b as a master. A femto BS 1b can select, as a master, both a macro BS 1a and another femto BS 1b.

The wireless communication system of the present embodiment is, for example, a mobile phone system to which LTE (Long Term Evolution) is applied, and communication based on LTE is performed between each base station device and each terminal device. In LTE, frequency division duplex (FDD) can be adopted. Hereinafter, a description will be given on assumption that the communication system adopts FDD. Note that the communication system is not limited to those based on LTE. Further, the scheme adopted by LTE is not limited to FDD. For example, TDD (Time Division Duplex) may be adopted.

[Frame Structure for LTE]

In FDD that can be adopted by LTE on which the communication system of the present embodiment is based, uplink communication and downlink communication are simultaneously performed by allocating different operating frequencies to an uplink signal (a transmission signal from a terminal device to a base station device) and a downlink signal (a transmission signal from the base station device to the terminal device).

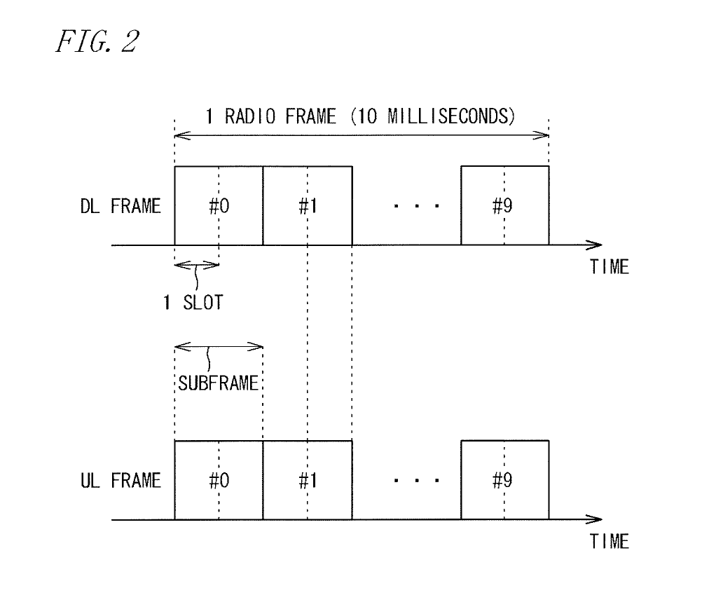

FIG. 2 is a diagram showing the structures of uplink and downlink communication frames for LTE. Each of a downlink frame (DL frame) and an uplink frame (UL frame) for LTE has a time length of 10 milliseconds per radio frame, and consists of 10 subframes #0 to #9. The DL frames and the UL frames are arranged in the time axis direction with the frame timings coinciding with each other.

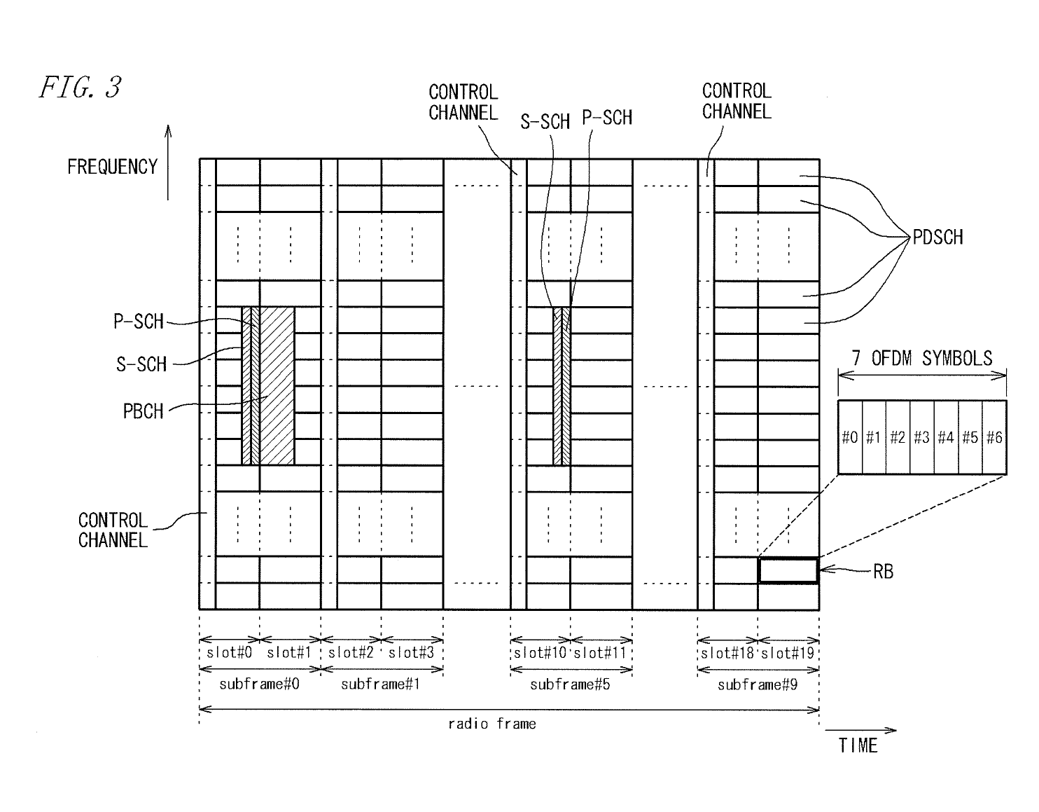

FIG. 3 is a diagram showing the structure of a DL frame in detail. In FIG. 3, the vertical axis direction indicates the frequency, and the horizontal axis direction indicates the time.

Each of subframes that form the DL frame consists of 2 slots (e.g., slots #0 and #1). One slot consists of 7 (#0 to #6) OFDM symbols (in the case of Normal Cyclic Prefix).

Further, in FIG. 3, a resource block (RB) which is a fundamental unit (minimum unit) for data transmission is defined by 12 subcarriers in the frequency axis direction and 7 OFDM symbols (1 slot) in the time axis direction. Accordingly, when the frequency band width of the DL frame is set at, for example, 5 MHz, 300 subcarriers are arranged, and 25 resource blocks are arranged in the frequency axis direction.

As shown in FIG. 3, a control channel for transmitting, from a base station device to a terminal device, information required for downlink communication is allocated to the beginning of each subframe. The control channel is allocated to symbols #0 to #2 (three symbols at maximum) in the front-side slot in each subframe. The control channel has, stored therein, DL control information, resource allocation information of the corresponding subframe, an acknowledgement (ACK) and a negative acknowledgement (NACK) in response to a hybrid automatic report request (HARQ), and the like.

Further, in the DL frame, a physical broadcast channel (PBCH) for notifying a terminal device of the band width or the like of the system by broadcasting is allocated to the first subframe #0. The physical broadcast channel is arranged, in the time axis direction, in the position corresponding to symbols #0 to #3 in the rear-side slot in the first subframe #0 so as to have a width corresponding to 4 symbols, and arranged, in the frequency axis direction, in the center of the band width of the DL frame so as to have a width corresponding to 6 resource blocks (72 subcarriers). The physical broadcast channel is configured to be updated every 40 milliseconds by transmitting the same information over four frames.

The physical broadcast channel has, stored therein, major system information such as the communication band width, the number of transmission antennas, the structure of the control information, and the like.

Further, among the 10 subframes that form the DL frame, the 1st (#0) and 6th (#5) subframes are each allocated a primary synchronization channel (P-SCH) and a secondary synchronization channel (S-SCH) which are signals for identifying a base station device or a cell.

The primary synchronization channel is arranged, in the time axis direction, in the position corresponding to symbol #6 that is the last OFDM symbol in the front-side slot in each of subframes #0 and #5 so as to have a width corresponding to one symbol, and arranged, in the frequency axis direction, in the center of the band width of the DL frame so as to have a width corresponding to 6 resource blocks (72 subcarriers). The primary synchronization channel is information by which a terminal device identifies each of a plurality of (three) sectors into which a cell of a base station device is divided, and 3 patterns are defined.

The secondary synchronization channel is arranged, in the time axis direction, in the position corresponding to symbol #5 that is the second last OFDM symbol in the front-side slot in each of subframes #0 and #5 so as to have a width corresponding to one symbol, and arranged, in the frequency axis direction, in the center of the band width of the DL frame so as to have a width corresponding to 6 resource blocks (72 subcarriers). The secondary synchronization channel is information by which a terminal device identifies each of the communication areas (cells) of a plurality of base station devices, and 168 patterns are defined.

By combining the primary synchronization channel and the secondary synchronization channel, 504 (163×3) patterns are defined. When a terminal device obtains a primary synchronization channel and a secondary synchronization channel transmitted from a base station device, the terminal device can recognize in which sector of which base station device the terminal device exists.

A plurality of patterns that the primary synchronization channel and the secondary synchronization channel can take are defined in advance in the communication standard, and are known by each base station device and each terminal device. That is, each of the primary synchronization channel and the secondary synchronization channel is a known signal that can take a plurality of patterns.

The primary synchronization channel and the secondary synchronization channel are used not only for the case where a terminal device achieves synchronization with a base station device, but also for inter-base-station synchronization in which the communication timings and/or frequencies are synchronized among base station devices. This will be described later.

The resource blocks in a region (a region without hatching in FIG. 3) to which the above-mentioned channels are not allocated are used as a physical downlink shared channel (PDSCH) in which user data and the like are stored. The physical downlink shared channel is an area shared for communication by a plurality of terminal devices, and control information and the like for each individual terminal device is stored therein as well as the user data.

Allocation of the user data to be stored in the physical downlink shared channel is defined by resource allocation information in the control channel that is allocated to the beginning of each subframe, and the resource allocation information allows a terminal device to determine whether data for the terminal device is stored in the subframe.

[Configuration of Femto Base Station Device]

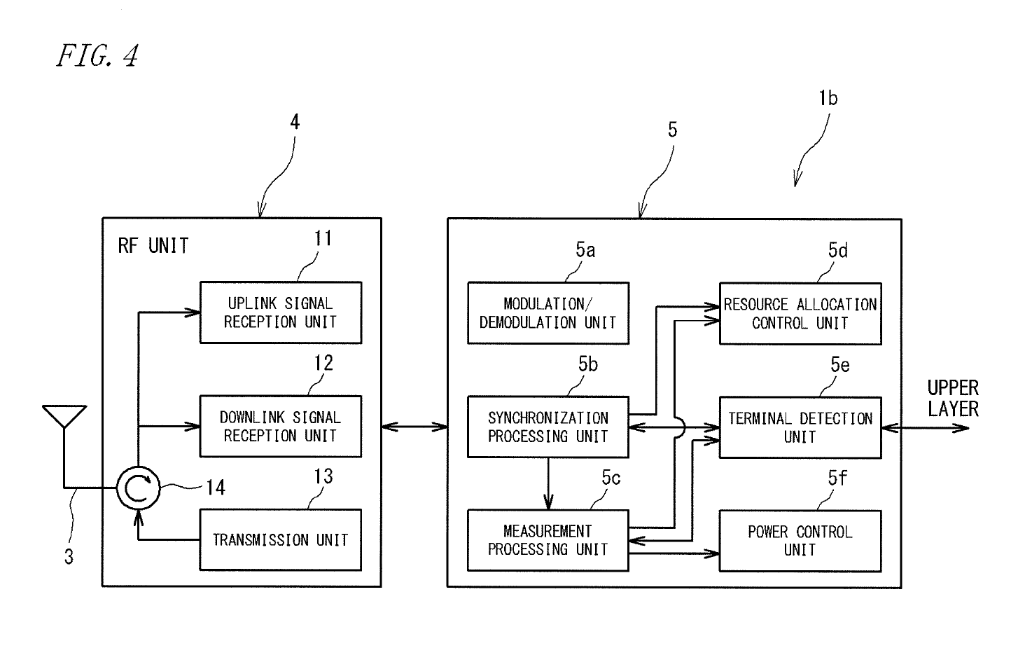

FIG. 4 is a block diagram showing the configuration of a femto BS 1b shown in FIG. 1. Although the configuration of the femto BS 1b will be described hereinafter, the configuration of a macro BS 1a is substantially the same as the femto BS 1b.

A femto BS 1b1 includes an antenna 3, a transmission/reception unit (RF unit) 4 to which the antenna 3 is connected, and a signal processing unit 5 that performs a signal processing for signals transmitted to and received from the RF unit 4, a process relating to inter-base-station synchronization, measurement, and the like.

[RF Unit]

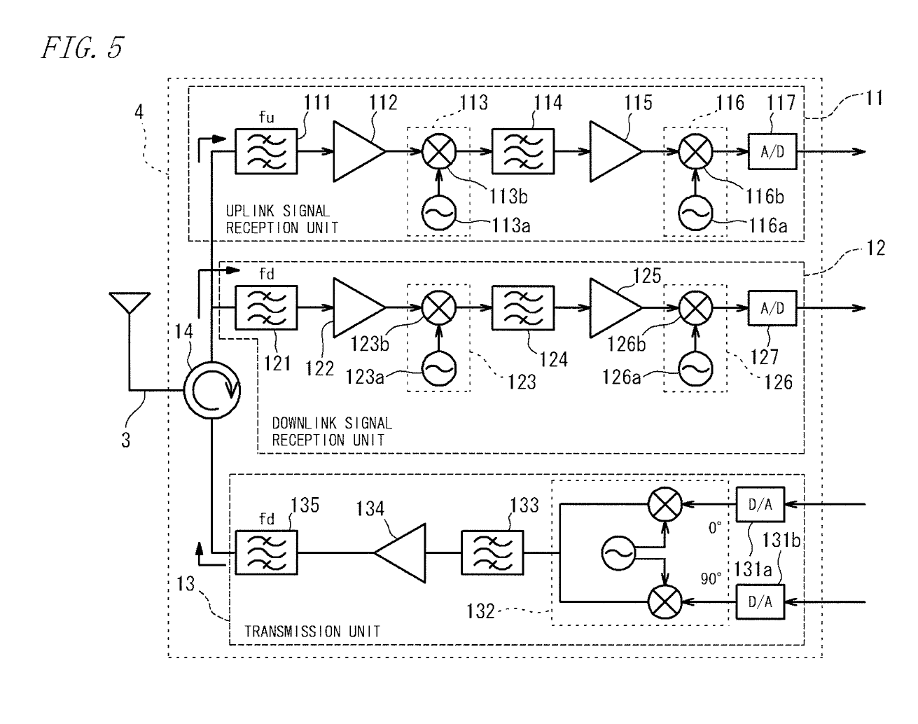

FIG. 5 is a block diagram showing the RF unit 4 in detail. The RF unit 4 includes an uplink signal reception unit 11, a downlink signal reception unit 12, and a transmission unit 13. The uplink signal reception unit 11 receives an uplink signal from a terminal device 2, and the downlink signal reception unit 12 receives a downlink signal from another macro BS 1a or another femto BS 1b. The transmission unit 13 transmits a downlink signal to the terminal device 2.

The RF unit 4 further includes a circulator 14. The circulator 14 provides a reception signal from the antenna 3 to the uplink signal reception unit 11 and to the downlink signal reception unit 12, and provides a transmission signal outputted from the transmission unit 13 to the antenna 3. The circulator 14 and a fourth filter 135 in the transmission unit 13 prevent the reception signal from the antenna 3 from being transmitted to the transmission unit 13.

Further, the circulator 14 and a first filter 111 in the uplink signal reception unit prevent the transmission signal outputted from the transmission unit 13 from being transmitted to the uplink signal reception unit 11. Furthermore, the circulator 14 and a fifth filter 121 prevent the transmission signal outputted from the transmission unit 13 from being transmitted to the uplink signal reception unit 12.

The uplink signal reception unit 11 is configured as a superheterodyne receiver so as to perform IF (Intermediate Frequency) sampling. More specifically, the uplink signal reception unit 11 includes a first filter 111, a first amplifier 112, a first frequency converter 113, a second filter 114, a second amplifier 115, a second frequency converter 116, and an A/D converter 117.

The first filter 111 allows only the uplink signal from the terminal device 2 to pass therethrough, and is implemented by a band-pass filter that allows only the frequency fᵤ of the uplink signal to pass therethrough. The reception signal having passed through the first filter 111 is amplified by the first amplifier (high-frequency amplifier) 112, and then subjected to frequency conversion from the frequency fᵤ to a first intermediate frequency by the first frequency converter 113. Note that the first frequency converter 113 includes an oscillator 113a and a mixer 113b.

The output from the first frequency converter 113 passes through a second filter 114 that allows only the first intermediate frequency to pass therethrough, and is again amplified by the second amplifier (intermediate frequency amplifier) 115. The output from the second amplifier 115 is subjected to frequency conversion from the first intermediate frequency to a second intermediate frequency by the second frequency converter 116, and is converted to a digital signal by the A/D converter 117. Note that the second frequency converter 116 also includes an oscillator 116a and a mixer 116b.

The output from the A/D converter 117 (the output from the first reception unit 11) is provided to the signal processing unit 5 that also functions as a demodulation circuit, and a demodulation process for the reception signal from the terminal device is performed.

Thus, the uplink signal reception unit 11 is a reception unit configured to comply with the uplink signal frequency fᵤ so as to receive the uplink signal from the terminal device, and is a reception unit that the base station device essentially requires.

The transmission unit 13 receives an in-phase signal I and a quadrature signal Q outputted from the signal processing unit 5, and causes the antenna 3 to transmit the signals. Thus, the transmission unit 13 is configured as a direct conversion transmitter. The transmission unit 13 includes D/A converters 131a and 131b, an orthogonal modulator 132, a third filter 133, a third amplifier (high power amplifier; HPA) 134, and a fourth filter 135.

The D/A converters 131a and 131b perform D/A conversion on the in-phase signal I and the quadrature signal Q provided from the signal processing unit 5, respectively. The outputs from the D/A converters 131a and 131b are provided to the orthogonal modulator 132, and the orthogonal modulator 132 generates a transmission signal having a carrier wave frequency f_{d} (downlink signal frequency).

The output from the orthogonal modulator 132 passes through the third filter 133 that allows only the frequency f_{d} to pass therethrough, and is amplified by the third amplifier 134. The output from the third amplifier 134 passes through the fourth filter 135 that allows only the frequency f_{d} to pass therethrough, and is transmitted from the antenna 3 as a downlink signal to the terminal device.

While the uplink signal reception unit 11 and the transmission unit 13 are functions necessary for performing essential communication with the terminal device as described above, the base station device 1 of the present embodiment further includes the downlink signal reception unit 12. The downlink signal reception unit 12 receives a downlink signal transmitted by another base station device.

In the present embodiment, a downlink signal that has been received from another base station device by the downlink signal reception unit 12 is used for an inter-base-station synchronization process and for measurement of the transmission state such as the transmission power of the another base station device.

The frequency of the downlink signal transmitted by the another base station device is f_{d} which is different from the frequency fᵤ of the uplink signal. Therefore, a common base station device having only the uplink signal processing unit 11 cannot receive the downlink signal transmitted by the another base station device.

That is, in contrast to TDD, in FDD, an uplink signal and a downlink signal simultaneously exist on a transmission path. Therefore, the uplink signal reception unit 11 is configured so that only a signal of the uplink signal frequency fᵤ is allowed to pass therethrough while a signal of the downlink signal frequency f_{d} is not allowed to pass therethrough. Specifically, the uplink signal reception unit 11 includes the first filter 111 that allows only a signal of the uplink signal frequency fᵤ to pass therethrough, and the second filter 114 that allows only the first intermediate frequency into which the frequency fᵤ is converted to pass therethrough. Therefore, if a signal of a frequency (the downlink signal frequency f_{d}) other than the frequency fᵤ is provided to the first reception unit 11, the signal is not allowed to pass through the uplink signal reception unit 11.

That is, the uplink signal reception unit 11 including the filters 111 and 114 is suited to reception of a signal of the uplink signal frequency fᵤ, and therefore, cannot receive signals of other frequencies (particularly, the downlink signal).

Accordingly, the RF unit 4 of the present embodiment includes, separately from the uplink signal reception unit 11, the downlink signal reception unit 12 for receiving a downlink signal of the frequency f_{d} transmitted by another base station device.

The downlink signal reception unit 12 includes a fifth filter 121, a fourth amplifier (high-frequency amplifier) 122, a third frequency converter 123, a sixth filter 124, a fifth amplifier (intermediate frequency amplifier) 125, a fourth frequency converter 126, and an A/D converter 127.

The fifth filter 121 allows only a downlink signal from another base station device to pass therethrough, and is implemented by a band-pass filter that allows only the downlink-signal frequency f_{d} to pass therethrough. The reception signal having passed through the fifth filter 121 is amplified by the fourth amplifier (high-frequency amplifier) 122. The output from the fourth amplifier 122 is subjected to frequency conversion from the downlink signal frequency f_{d} to the first intermediate frequency by the third frequency converter 123. Note that the third frequency converter 123 includes an oscillator 123a and a mixer 123b.

The output from the third frequency converter 123 passes through the sixth filter 124 that allows only the first intermediate frequency outputted from the third frequency converter 123 to pass therethrough, and is again amplified by the fifth amplifier (intermediate frequency amplifier) 125. The output from the fifth amplifier 125 is subjected to frequency conversion from the first intermediate frequency to the second intermediate frequency by the fourth frequency converter 126, and is further converted into a digital signal by the A/D converter 127. Note that the fourth frequency converter 126 also includes an oscillator 126a and a mixer 126b.

The signal outputted from the A/D converter 127 is provided to a synchronization processing unit 5b and a measurement processing unit 5c included in the signal processing unit 5, which will be described later.

Note that each of the uplink signal reception unit 11 and the downlink signal reception unit 11 may be configured as a direct conversion receiver.

It is preferable that symmetry of uplink and downlink signals in the downlink signal reception unit 11 and the transmission unit 13 is secured by antenna calibration. Such antenna calibration is realized by providing the downlink signal reception unit 11 and/or the transmission unit 13 with a gain/phase adjuster (not shown).

[Signal Processing Unit]

The signal processing unit 5 has a function for performing signal processing for signals transmitted to and received from the RF unit 4, and includes a modulation/demodulation unit 5a that modulates various transmission data supplied from an upper layer of the signal processing unit 5 to a transmission signal, and demodulates a reception signal supplied from the RF unit 4 to reception data. The modulation/demodulation unit 5a performs modulation and demodulation with a synchronization error being corrected, based on the synchronization error (timing offset, frequency offset) calculated by a synchronization processing unit 5b described later.

Further, the signal processing unit 5 includes a frame counter (not shown) that determines a transmission timing per radio frame for the transmission signal to be provided to the RF unit 4.

Further, the signal processing unit 5 includes a synchronization processing unit 5b that performs a synchronization process for achieving inter-base-station synchronization with another base station device, a measurement processing unit 5c that performs measurement, a resource allocation control unit 5d, and a terminal detection unit 5e that detects the communication states of terminal devices connected to its own base station device and other base station devices.

[Synchronization Processing Unit]

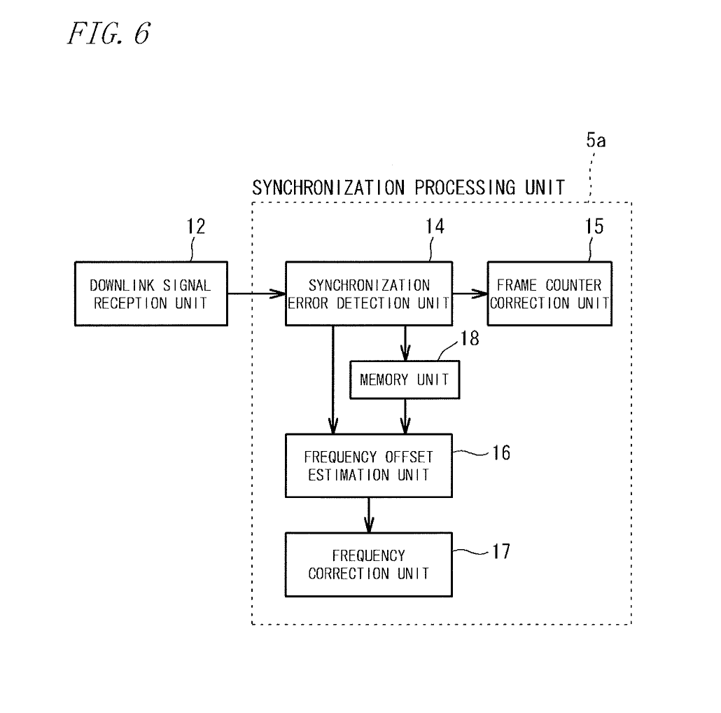

FIG. 6 is a block diagram showing the configuration of the synchronization processing unit 5b that performs a synchronization process for achieving inter-base-station synchronization with another base station device.

Such inter-base-station synchronization may be achieved by providing each of the base station devices with a GPS receiver so that the base station devices can achieve synchronization by using GPS signals, or by connecting the base station devices via a cable. However, the present embodiment adopts inter-base-station synchronization based on “over-the-air synchronization” in which synchronization is achieved by using radio signals (downlink signals).

Specifically, the synchronization processing unit 5b obtains a downlink signal from another base station device, which is received by the downlink signal reception unit 12, and performs a synchronization process for synchronizing the communication timing and the communication frequency of its own base station device 1 with those of the another base station device, based on a primary synchronization channel (P-SCH) and a secondary synchronization channel (S-SCH) that are known signals included in a frame of the downlink signal.

The synchronization processing unit 5b sets, in units of subframes, a timing to obtain a downlink signal from another base station device, which is provided from the downlink signal reception unit 12, such that the synchronization process is performed at a predetermined cycle.

Further, the synchronization processing unit 5b has a function of adjusting the timing to perform the synchronization process by adjusting the cycle of the timing to obtain the downlink signal for the synchronization process in accordance with the detection result of the terminal detection unit 5e.

The synchronization processing unit 5b starts the synchronization process by causing the transmission unit 13 to suspend transmission of a transmission signal, in a section of a subframe corresponding to the timing to obtain the downlink signal (synchronization process start timing), which timing has been set by the synchronization processing unit 5b. While transmission of the transmission signal is suspended, the synchronization processing unit 5b causes the downlink signal reception unit 12 to receive a downlink signal from another base station device, and obtains the received downlink signal. Then, using the downlink signal, the synchronization processing unit 5b corrects its own frame timing and communication frequency, and ends the synchronization process. Note that the section for which transmission of the transmission signal is suspended may be set to a subframe corresponding to the timing at which the downlink signal for the synchronization process is obtained, and to subsequent one or more subframes.

In addition to the suspension of transmission of the transmission signal described above, suspension of reception of an uplink signal from a terminal device may be performed.

Further, the synchronization processing unit 5b outputs, to the resource allocation control unit 5d and the measurement processing unit 5c, synchronization timing information for specifying a subframe corresponding to the section for which transmission of the transmission signal is suspended.

The synchronization processing unit 5b includes a synchronization error detection unit 14, a frame counter correction unit 15, a frequency offset estimation unit 16, a frequency correction unit 17, and a memory unit 18, and has a function of performing synchronization of frame transmission timings, and correcting a carrier frequency.

The synchronization error detection unit 14 detects a frame transmission timing of another base station device by using the known signals included in a downlink signal, and detects an error (frame synchronization error; communication timing offset) between the detected frame transmission timing and the frame transmission timing of the own base station device 1.

Note that detection of transmission timing can be performed by detecting the timings of the primary synchronization channel and the secondary synchronization channel, which are known signals (waveforms thereof are also known) each existing in a predetermined position in the frame of the received downlink signal.

The synchronization error detection unit 14 provides the detected frame synchronization error to the frame counter correction unit 15, and to the memory unit 18 each time a frame synchronization error is detected. These detected frame synchronization errors are accumulated in the memory unit 18.

The frame synchronization error detected by the synchronization error detection unit 14 is provided to the frame counter correction unit 15. The frame counter correction unit 15 corrects the value of the frame counter that determines the frame transmission timing, in accordance with the detected frame synchronization error. Thereby, the femto BS 1b can achieve synchronization with the another base station device.

The frequency offset estimation unit 16 estimates, based on the synchronization error detected by the detection unit 14, a difference (clock frequency error) between a clock frequency of a clock generator (not shown) contained in the base station device as the receiving side and a clock frequency of a clock generator contained in the another base station device as the transmitting side, and estimates a carrier frequency error (carrier frequency offset) from the clock frequency error.

Under the situation where over-the-air synchronization is periodically performed, the frequency offset estimation unit 16 estimates a clock error based on a frame synchronization error t1 detected in the last over-the-air synchronization and a frame synchronization error t2 detected in the current over-the-air synchronization. Note that the last frame synchronization error t1 can be obtained from the memory unit 18.

For example, it is assumed that, when the carrier frequency is 2.6 [GHz], a frame synchronization error T1 has been detected at the timing of the last over-the-air synchronization (synchronization timing=t1), and correction of timing by an amount corresponding to T1 has been performed. The synchronization error (timing offset) after the correction is 0 [msec]. Then, it is assumed that, also at the timing of the current over-the-air synchronization (synchronization timing=t2) performed T=10 seconds later, a synchronization error (timing offset) is detected again, and the synchronization error (timing offset) is T2=0.1 [msec].

At this time, the synchronization error (timing offset) of 0.1 [msec] having occurred during the 10 seconds is an accumulated value of the error between the clock period of the another base station device and the clock period of the own base station device.

That is, the following equation is established between the synchronization error (timing offset) and the clock period.

the clock period of the synchronization-source base station: the clock period of the synchronization-target base station=T:(T+T2)=10:(10+0.0001)

Since the clock frequency is the reciprocal of the clock period,

$$( the clock frequency of the synchronization \text{-} source base station - the clock frequency of the synchronization \text{-} target base station ) = the clock frequency of the synchronization \text{-} source base station \times T 2 / ( T + T 2 ) \approx the clock frequency of the synchronization \text{-} source base station \times 0.00001$$

Accordingly, in this case, there is an error of 0.00001=10 [ppm] between the clock frequency of the another base station device as the transmitting side and the clock frequency of the own base station device as the receiving side. The frequency offset estimation unit 16 estimates the clock frequency error in the above-described manner.

Since the carrier frequency and the synchronization error (timing offset) are shifted in the same manner, an error of an amount corresponding to 10 [ppm], i.e., an error of 2.6 [GHz]×1×10⁻⁵=26 [kHz], also occurs in the carrier frequency. Thus, the frequency offset estimation unit 16 can also estimate the carrier frequency error (carrier frequency offset) from the clock frequency error.

The carrier frequency error estimated by the frequency offset estimation unit 16 is provided to the frequency correction unit 17.

The frequency correction unit 17 corrects the carrier frequency based on the carrier frequency error. Note that the frequency correction unit 17 can correct not only the carrier frequency of the uplink signal but also the carrier frequency of the downlink signal.

Next, functions of the measurement processing unit 5c will be described.

[Measurement Processing Unit]

The measurement processing unit 5c has a function of performing measurement (measurement process) of the transmission state of a downlink signal, such as the transmission power and the operating frequency of another base station device. The measurement processing unit 5c obtains a downlink signal from another base station device, which is received by the downlink signal reception unit 12, and obtains the reception power (reception level) of the downlink signal.

The measurement processing unit 5c sets, in units of subframes, the timing to obtain a downlink signal for performing the measurement process. Further, the measurement processing unit 5c has a function of adjusting the timing to perform the measurement process by setting and adjusting the timing to obtain the downlink signal for the measurement process in accordance with the detection result of the terminal detection unit 5e.

Note that it is preferable that the measurement process is performed immediately after the synchronization process, as described later. Therefore, the measurement processing unit 5c sets the timing to perform the measurement process in accordance with the synchronization timing information provided from the synchronization processing unit 5b.

For example, the measurement processing unit 5c specifies, based on the received synchronization timing information, a subframe at which the synchronization process is started, and sets the measurement process to be performed at a subframe that belongs to a radio frame subsequent to a radio frame to which the specified subframe belongs.

The measurement processing unit 5c starts the measurement process by causing the transmission unit 13 to suspend transmission of the transmission signal, in a section of a subframe corresponding to the timing to obtain a downlink signal for the measurement process (the measurement process start timing), which timing has been set by the measurement processing unit 5c. While transmission of the transmission signal is suspended, the measurement processing unit 5c causes the downlink signal reception unit 12 to receive the downlink signal from the another base station device, and obtains the received downlink signal. Thereafter, the measurement processing unit 5c measures the reception power and the like of the downlink signal, and ends the measurement process. Note that the section for which transmission of the transmission signal is suspended may be set to a subframe corresponding to the timing at which the downlink signal is obtained, and to subsequent one or more subframes.

In addition to the suspension of transmission of the transmission signal described above, suspension of reception of an uplink signal from a terminal device may be performed.

Further, the measurement processing unit 5c outputs, to the resource allocation control unit 5d, measurement timing information for specifying a subframe corresponding to a section during which transmission of the transmission signal is suspended.

The measurement processing unit 5c determines an average value of the reception power (average power value) for each resource block, based on the downlink signal obtained from the downlink signal reception unit 12.

The measurement processing unit 5c extracts, from the obtained downlink signal, portions assumed to correspond to resource block units, separately from each other in the time axis direction. Further, from each of the extracted portions, the measurement processing unit 5c extracts a portion corresponding to the frequency width of each resource block, and determines the power of the portion of each frequency width as an average power value of the corresponding resource block.

After determining the average power value, the measurement processing unit 5c outputs measurement result information indicating the average power value to the resource allocation control unit 5d, the terminal detection unit 5e, and an power control unit 5f.

The measurement processing unit 5c obtains the downlink signal, which is a signal having been subjected to orthogonal modulation (before being subjected to demodulation) obtained from the downlink signal reception unit 12, and determines the average power value for each resource block from this signal. Thus, the measurement processing unit 5c extracts, from this signal, the portions assumed to correspond to the resource block units, separately from each other in the time axis direction. Therefore, the measurement processing unit 5c needs to recognize the frame timing of the another base station device that is a transmission source of the downlink signal.

Here, if the frame timing synchronization has been achieved between the another base station device and the own base station device, the measurement processing unit 5c can grasp the frame timing of the another base station device, from the frame timing of the own base station device, and thus, the measurement processing unit 5c can accurately estimate the units of resource blocks in the time axis direction and can accurately determine the average power values. For this reason, it is preferable that the measurement process is performed immediately after the synchronization process.

[Terminal Detection Unit]

The terminal detection unit 5e has a function of detecting the state of communication with MSs 2 connected to its own base station device and another base station device.

More specifically, the terminal detection unit 5e detects, as the communication state, the number of MSs 2 that are currently connected to the own base station device and to the another base station device.

Note that MSs 2 connected to the another base station device, the MSs 2 being the detection target by the terminal detection unit 5e, are MSs 2 which a downlink signal from the own base station device may reach.

The terminal detection unit 5e obtains information of the number of MSs 2 connected to the own base station device, from an upper layer of the signal processing unit 5.

Meanwhile, the number of MSs 2 connected to the another base station device is estimated based on the measurement result information from the measurement processing unit 5c.

The measurement process is performed by receiving a downlink signal from another base station device. The another base station device, being located near the own base station device, is a base station device located within a range in which a downlink signal from the own base station device can reach the another base station device and a downlink signal from the another base station device can reach the own base station device. Accordingly, the downlink signal of the own base station device may reach an MS 2 connected to the another base station device.

Therefore, the terminal detection unit 5e can detect an MS 2 which a downlink signal of the own base station device may reach, based on the measurement result information regarding the downlink signal of the another base station device described above.

The terminal detection unit 5e determines whether MSs 2 are connected to another base station device, based on the average power values of the respective resource blocks included in the measurement result information, and estimates the number of MSs 2 connected to the another base station device. That is, if the another base station device is communicating with an MS 2 in the cell of the own base station device, user data directed to the MS 2 is allocated in its transmission signal, and the power corresponding to the portion to which such data is allocated is relatively increased compared to the power corresponding to the portion to which such data is not allocated. Accordingly, the terminal detection unit 5e can determine whether an MS2 is connected to the another base station device, based on the reception power of the transmission signal.

When it is determined that an MS 2 is connected, it is possible to determine whether user data is allocated to each of the resource blocks. Therefore, the terminal detection unit 5e can estimate the number of MSs 2 connected to the another base station device, based on the allocation state.

[Resource Allocation Control Unit and Power Control Unit]

The resource allocation control unit 5d has a function of allocating, in a physical downlink shared channel in a radio frame, user data to be transmitted to each terminal device 2.

When receiving the synchronization timing information and the measurement timing information from the synchronization processing unit 5b and the measurement control unit 5f, respectively, the resource allocation control unit 5d restricts allocation of user data to subframes specified by these pieces of information. Further, when receiving the measurement result information from the measurement processing unit 5c, the resource allocation control unit 5d determines allocation of user data, based on the information.

The power control unit 5f has a function of controlling transmission power of the transmission unit 13 included in the RF unit 4. When receiving the average power value of the another base station device determined by the measurement processing unit 5c, the power control unit 5f adjusts its own transmission power based on the average power value, such that the own transmission signal does not interfere with the another base station device and the MS 2 connected to the another base station device.

[Synchronization Process]

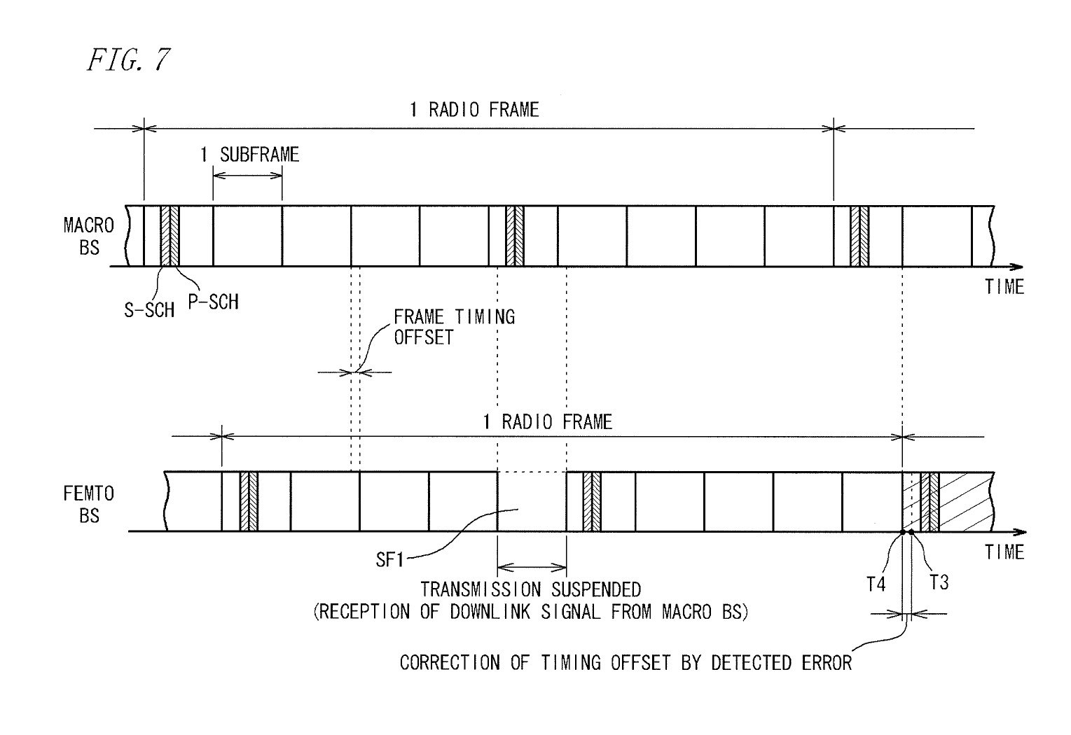

FIG. 7 is a diagram for explaining an example of a synchronization process performed by the synchronization processing unit. FIG. 7 shows a frame transmitted by a macro BS 1a serving as another base station device and a frame transmitted by a femto BS 1b serving as the own base station device on the same time axis, and shows an example in which the femto BS 1b performs synchronization based on a downlink signal from the macro BS 1a serving as a synchronization source.

FIG. 7 shows a state where an offset in the frame transmission timings occurs: that is, in a section before the timing T4, a timing offset occurs between the beginning of each subframe of the femto BS 1b and the beginning of a corresponding subframe of the macro BS 1a.

In a case where the synchronization processing unit 5b of the femto BS 1b has set, to a subframe SF1, a timing to obtain a downlink signal for the synchronization process, the synchronization processing unit 5b outputs synchronization timing information including information for specifying the subframe SF1 to the resource allocation control unit 5d and the measurement processing unit 5c. Note that, in FIG. 7, the section during which transmission of a transmission signal is suspended is set to only the section of the subframe SF1 which corresponds to the timing at which the synchronization process is started.

When the radio frame is transmitted, the synchronization processing unit 5b causes, at the transmission timing of the subframe SF1, the transmission unit 13 to suspend transmission of the transmission signal, and the downlink signal reception unit 12 to receive a downlink signal of the macro BS 1a, and obtains the received downlink signal.

Then, the synchronization processing unit 5b detects the frame transmission timing of the macro BS 1a, using the primary synchronization channel and the secondary synchronization channel included in the received downlink signal of the macro BS1a, and detects a frame synchronization error between the own frame transmission timing and the frame transmission timing of the macro BS1a.

Note that the synchronization processing unit 5b has, stored therein, the timing at which the primary synchronization channel and the secondary synchronization channel existed in the downlink signal of the macro BS 1a in the synchronization process performed in the past, and sets the transmission signal to be suspended in the section of the subframe that corresponds to the timing.

Meanwhile, the resource allocation control unit 5d, provided with the synchronization timing information, limits allocation of user data of the terminal device 2 to the section of the subframe SF1. Accordingly, even if the terminal device 2 cannot communicate with the femto BS1b as the result of the transmission suspension of the transmission signal in this section, the terminal device 2 does not scan a base station in vain or determine that some abnormality has occurred, and thus can maintain smooth communication.

Based on the detected frame synchronization error, the synchronization processing unit 5b achieves synchronization by correcting the timing of the beginning of a radio frame subsequent to the radio frame to which the subframe SF1 belongs. For example, if it is assumed that the beginning of the radio frame before synchronization is performed is the timing T3, the synchronization processing unit 5b corrects the value of the frame counter such that the beginning of the radio frame coincides with the timing T4, which is a timing shifted by the above error from the timing T3. Accordingly, it is possible to cause the frame timing of the own femto BS 1b to coincide with the frame timing of the macro BS 1a, whereby synchronization can be achieved.

Although only the synchronization of the frame timing has been described above, correction of the carrier frequency is performed in a similar manner.

[Measurement Process]

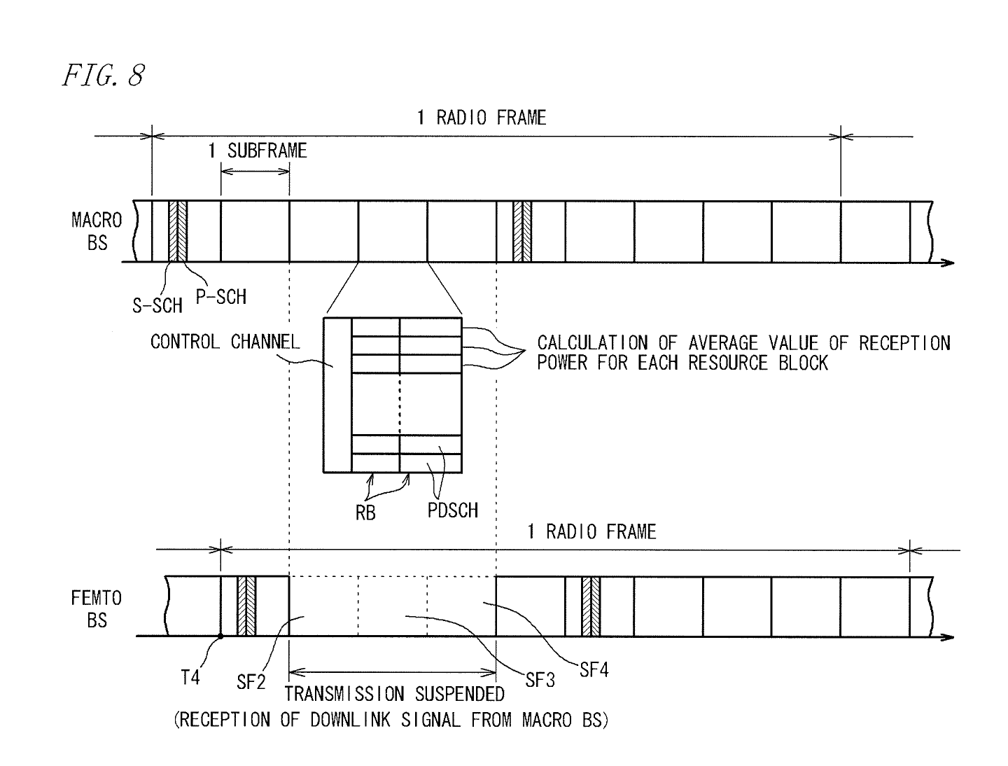

FIG. 8 is a diagram for explaining an example of the measurement process performed by the measurement processing unit 5c. FIG. 8 shows a frame transmitted by a macro BS 1a serving as another base station device and a frame transmitted by a femto BS 1b serving as the own base station device on the same time axis, and shows an example in which the femto BS1b performs the measurement process based on the downlink signal of the macro BS1a.

The measurement processing unit 5c can specify a subframe that corresponds to the timing at which the synchronization processing unit 5b starts the synchronization process, based on the synchronization timing information provided from the synchronization processing unit 5b.

The measurement processing unit 5c performs setting such that the measurement process is performed in a radio frame subsequent to the radio frame to which the subframe that corresponds to the specified synchronization process start timing belongs. That is, as shown in FIG. 8, the measurement process is performed in a radio frame located immediately after the radio frame where the synchronization has been achieved at the timing T4.

The measurement processing unit 5c sets the start timing of the measurement process to a subframe SF2 in FIG. 8. Then, the measurement processing unit 5c outputs, to the resource allocation control unit 5d, measurement timing information containing information for specifying a subframe that corresponds to a section during which transmit of a transmission signal is to be suspended for performing the measurement process.

In the present embodiment, the measurement processing unit 5c sets the section during which the transmission of the transmission signal is to be suspended for performing the measurement process, to three subframes, that is, the subframe corresponding to the start timing and two subframes that follow the subframe. Accordingly, as shown in FIG. 8, the measurement processing unit 5c causes the transmission unit 13 to suspend transmission of the transmission signal for the section corresponding to the subframes SF2, SF3, and SF4.

Thus, the measurement processing unit 5c outputs, to the resource allocation control unit 5d, the measurement timing information containing information for specifying these subframe SF2 to SF4.

While causing the transmission unit 13 to suspend transmission of the transmission signal at the transmission timings corresponding to the subframes SF2 to SF4 when the radio frame is transmitted, the measurement processing unit 5c causes the downlink signal reception unit 12 to receive a downlink signal of the macro BS1a, and obtains the received downlink signal. Then, the measurement processing unit 5c determines the average power value for each resource block, based on the obtained downlink signal.

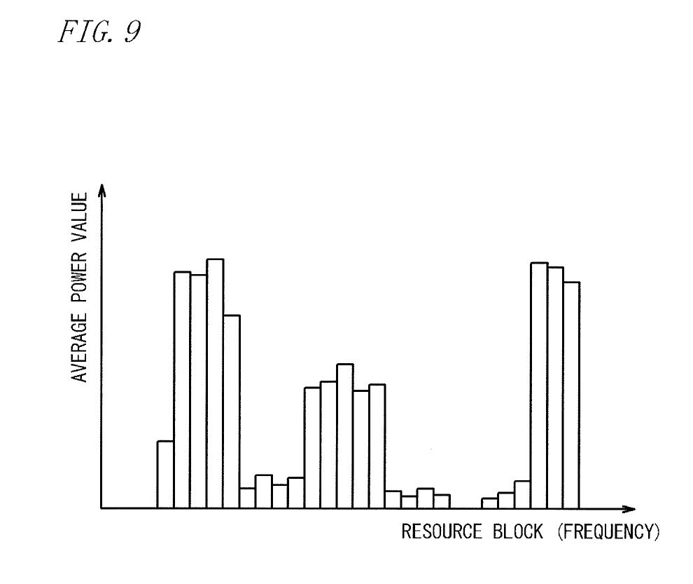

FIG. 9 is a diagram showing an example of average power values for respective resource blocks, which are determined by the measurement processing unit 5c. In FIG. 9, the horizontal axis represents the resource blocks arranged in the frequency direction, and the vertical axis represents the average power value.

As shown in FIG. 9, some resource blocks have high average power values and other resource blocks have low average power values, and it is indicated that user data is allocated to the resource blocks having high average power values.

Based on the obtained downlink signal, the measurement processing unit 5c determines data as shown in FIG. 9 for each time period assumed to correspond to a resource block width in the symbol direction, and obtains an average power value for each resource block contained in the obtained downlink signal.

Meanwhile, the resource allocation control unit 5d, provided with the measurement timing information, restricts allocation of user data of the terminal device 2 to the section corresponding to the subframes SF2 to SF4. Therefore, even if the terminal device 2 cannot communicate with the femto BS1b as the result of the transmission suspension of the transmission signal in this section, the terminal device 2 can maintain smooth communication as in the case of the synchronization process.

After determining the average power value for each resource block, the measurement processing unit 5c outputs measurement result information containing these values to the resource allocation control unit 5d, the terminal detection unit 5e, and the power control unit 5f.

The resource allocation control unit 5d and the power control unit 5f which have been provided with the measurement result information perform, based on the measurement result information, respective processes so as to suppress occurrence of interference with the another base station device.

Specifically, the measurement result information contains the average power value for each resource block in the downlink signal from the another base station device, and thus allows recognition of the main frequency band currently used in the communication with MSs 2 by the another base station device.

For example, as shown in FIG. 9, since user data to an MS 2 is not allocated in a frequency band in which a low average power value appears, it is possible to assume that this frequency band is not currently used by the another base station device.

The resource allocation control unit 5d allocates its own user data so as to preferentially use the frequency band that is assumed not to be used by the another base station device. Accordingly, it is possible to prevent as much as possible, the band used by the own base station device from overlapping the band used by the another base station device, and it is possible to suppress occurrence of interference with the another base station device and with an MS2 connected to the another base station device.

Moreover, the power control unit 5f estimates the transmission power of the another base station device based on the average power values obtained from the measurement result information, and adjusts the own transmission power based on the transmission power of the another base station device. For example, the power control unit 5f adjusts the own transmission power so as to be reduced, when determining that the own transmission power is relatively greater than the transmission power of the another base station device and interference will occur.

[Timings of Synchronization Process and Measurement Process]

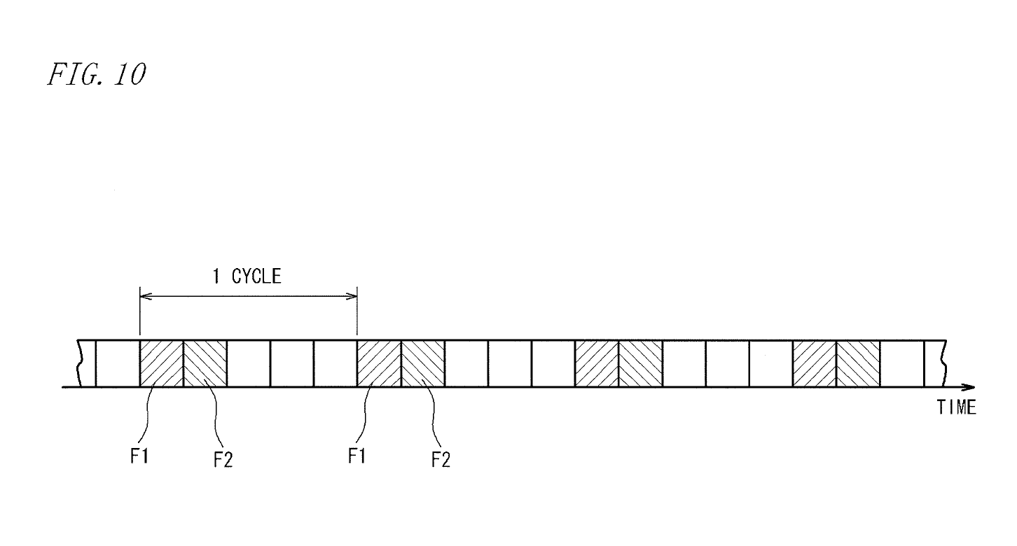

FIG. 10 is a diagram showing timings at which the synchronization process and the measurement process are performed. FIG. 10 shows, among a plurality of radio frames arranged in the time axis direction, arrangement of radio frames F1 which each contain a subframe in which the synchronization process is performed and radio frames F2 which each contain a subframe in which the measurement process is performed.

In the present embodiment, the synchronization processing unit 5b sets the timing to perform the synchronization process such that the synchronization process is performed in a constant cycle. Moreover, the measurement processing unit 5c performs setting such that the measurement process is performed in a subframe contained in a radio frame F2 subsequent to a radio frame F1 in which the synchronization processing unit 5b performs the synchronization process.

FIG. 10 shows a case where the synchronization process is set to be performed in a cycle corresponding to five radio frames.

The synchronization processing unit 5b adjusts the timing to perform the synchronization process by adjusting the cycle of the synchronization process start timing in accordance with a detection result by the terminal detection unit 5e.

The terminal detection unit 5e estimates the number of MSs 2 connected to the another base station device, based on measurement result information obtained in the measurement process performed in a radio frame F2 before the synchronization process is performed. The terminal detection unit 5e obtains, from an upper layer, information about the number of MSs 2 connected to the own base station device, during a time period after the measurement process has been performed and before a frame in which the next synchronization process is performed.

The terminal detection unit 5e provides the synchronization processing unit 5b with information of the estimated number of MSs 2 connected to the another base station device and the number of MSs 2 connected to the own base station device, as a detection result.

The synchronization processing unit 5b, provided with these pieces of information, adjusts the cycle of the synchronization process start timing, in accordance with the estimated number of MSs 2 connected to the another base station device and the number of MSs 2 connected to the own base station device.

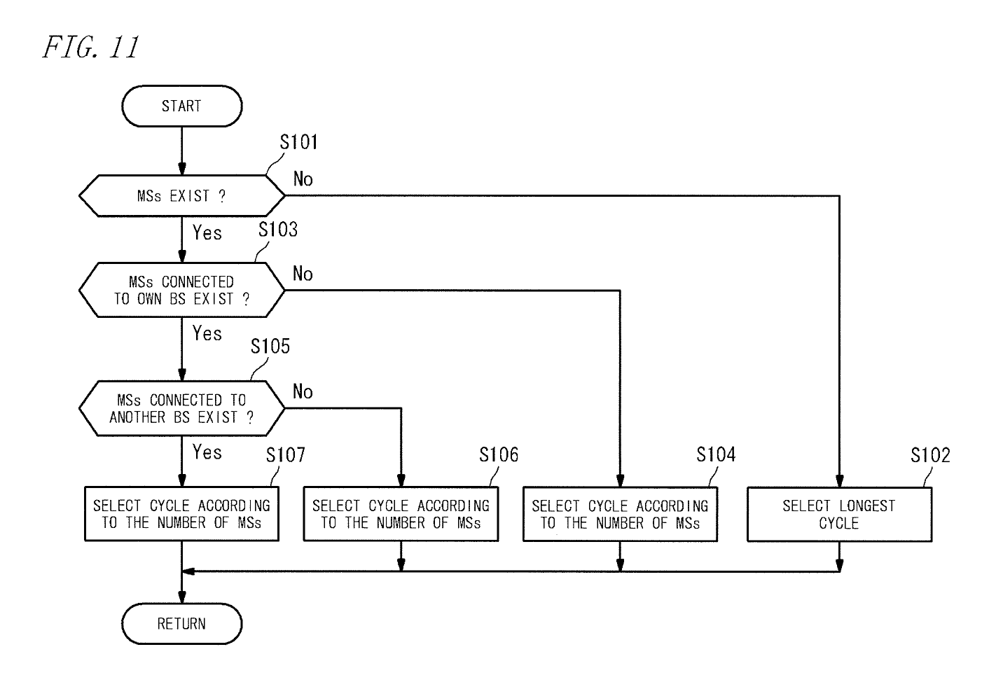

FIG. 11 is a flowchart showing a manner of adjusting the cycle of the synchronization process by the synchronization processing unit 5b.

In the present embodiment, the synchronization processing unit 5b has, stored therein, a group of cycles including a longest cycle that can be set as a cycle of the synchronization process, and a plurality of cycles shorter than the longest cycle. The synchronization processing unit 5b selects, as a cycle to perform the synchronization process, any of the longest cycle and the plurality of cycles included in the group of cycles. Note that the longest cycle is set to a maximum cycle in which a minimal accuracy of inter-base-station synchronization can be maintained.

The synchronization processing unit 5b, when provided with the detection result from the terminal detection unit 5e, determines whether there are MSs 2 connected to its own base station device and to another base station device (step S101). Upon determining that no MSs 2 are connected to the own base station device and the another base station device, the synchronization processing unit 5b selects and sets the longest cycle that is a possible maximum cycle as a cycle to perform the synchronization process (step S102), and ends the process.

When determining in step S101 that there are MSs 2 connected to the own base station device and the another base station device, the synchronization processing unit 5b determines whether there are MSs 2 connected to the own base station device (step S103). Upon determining that there are no MSs 2 connected to the own base station device, the synchronization processing unit 5b can determine that there are only MSs 2 connected to the another base station device. In this case, the synchronization processing unit 5b selects a cycle from among the plurality of cycles included in the group of cycles, based on a predetermined standard, in accordance with the number of MSs 2 connected to the another base station device, and sets the selected cycle as a cycle of the synchronization process (step S104), and then ends the process.

When determining in step S103 that there are MSs 2 connected to the own base station device, the synchronization processing unit 5b determines whether there are MSs 2 connected to the another base station device (step S105). Upon determining that there are no MSs 2 connected to the another base station device, the synchronization processing unit 5b can determine that there are only MSs 2 connected to the own base station device. In this case, the synchronization processing unit 5b selects a cycle from among the plurality of cycles included in the group of cycles, based on the predetermined standard, in accordance with the number of MSs 2 connected to the own base station device, and sets the selected cycle as a cycle of the synchronization process (step S106), and then ends the process.

When determining in step S105 that there are MSs 2 connected to the another base station device, the synchronization processing unit 5b determines that there are MSs 2 connected to the own base station device and MSs 2 connected to the another base station device. In this case, the synchronization processing unit 5b selects a cycle from among the plurality of cycles included in the group of cycles, based on the predetermined standard, in according with the number of MSs 2 connected to the own base station device and the number of MSs 2 connected to the another base station device, and sets the selected cycle as a cycle of the synchronization process (step S107), and then ends the process.

In the above steps S104, S106, and S107, the synchronization processing unit 5b essentially selects a longer cycle as the number of MSs 2 is smaller.

That is, when there are no MSs 2 connected to the own base station device and the another base station device, the synchronization processing unit 5b selects the longest cycle, and adjusts the cycle of the synchronization process to be shorter with an increase in the number of MSs 2.

After the synchronization processing unit 5b has adjusted the cycle of the synchronization process, the measurement processing unit 5c sets a cycle of the measurement process in accordance with the cycle of the synchronization process.

According to the base station device of the above-mentioned configuration, the synchronization processing unit 5b adjusts the timing to start the synchronization process (the timing to obtain a signal for the synchronization process), based on the number of MSs 2 that is the communication state of MSs 2 connected to the own base station device and the another base station device. Therefore, the synchronization processing unit 5b can perform this process at a timing according to, for example, the necessity of the synchronization process that varies depending on the communication state with the MSs 2. As a result, it is possible to appropriately perform the process associated with reception of the transmission signal from the another base station device.

In the present embodiment adopting FDD, when a base station device achieves synchronization with another base station device, interference to MSs 2 is suppressed during cooperative transmission between the respective BSs, and reduction in the effect is suppressed during spatial multiplexing transmission. However, since these effects are directed to MSs, the necessity of achieving synchronization is reduced if there are no MSs 2 connected to the own base station device and no MSs 2 which a downlink signal from the own base station device might reach.

On the other hand, when a base station device is configured to perform the synchronization process in a constant cycle, the base station device periodically performs the synchronization process even if there are no MSs 2 and therefore the necessity of synchronization is low. In this case, the less necessary process is performed at relatively high frequency, resulting in a waste.

In this regard, in the base station device of the present embodiment, as described above, the synchronization processing unit 5b can adjust the cycle of the synchronization process in accordance with the number of MSs 2 connected to the own base station device and the number of MSs 2 that are connected to the another base station device and therefore are likely to receive a downlink signal from the own base station device. Specifically, when there are no MSs 2 connected to the own base station device and the another base station device and therefore the necessity of the synchronization process is low, the synchronization processing unit 5b selects and sets the longest cycle. That is, as the number of terminal devices connected to the own base station device and/or the another base station device is smaller, the synchronization processing unit 5b adjusts the cycle of the synchronization process to be longer. Thus, the frequency of the synchronization process can be reduced in accordance with the necessity of the synchronization process, thereby realizing efficient synchronization process.

Further, in the present embodiment, the measurement processing unit 5c sets the cycle of the measurement process in accordance with the cycle of the synchronization process adjusted by the synchronization processing unit 5b. However, the measurement processing unit 5c may set the timing to perform the measurement process at its own discretion according to need, regardless of the cycle of the synchronization process. In this case, the measurement processing unit 5c sets the timing to perform the measurement process based on the detection result of the terminal detection unit 5e, like the synchronization processing unit 5b.

Note that the present invention is not limited to the above-mentioned embodiment.

While the above-mentioned embodiment illustrates the case where the synchronization process is performed periodically, the timing of the synchronization process may be set each time the detection result of the terminal detection unit 5e is obtained.

Further, while the above-mentioned embodiment illustrates the case where the synchronization processing unit 5b sets the cycle of the synchronization process in accordance with the number of MSs 2 connected to the own base station device and another base station device, the synchronization processing unit 5b may set the cycle of the synchronization process in accordance with only the number of MSs 2 connected to the own base station device, or only the number of MSs 2 connected to another base station device.

Further, while in the above-mentioned embodiment, firstly the number of MSs 2 connected to the own base station device and the number of MSs 2 connected to another base station device are grasped, and thereafter, the respective numbers of MSs 2 are individually evaluated to set the cycle of the synchronization process. However, focusing on only the total number of MSs 2 connected to the own base station device and another base station device, the cycle of the synchronization process may be set in accordance with the total number.

Further, in the above-mentioned embodiment, in the synchronization process, the transmission signal is suspended, and a synchronization error is corrected at the beginning of the radio frame immediately after reception of a downlink signal from another base station device. However, for example, the synchronization error may be corrected at the beginning of a subframe other than the beginning of the radio frame. Further, in the synchronization process and the measurement process, a section for which the transmission signal is suspended may be arbitrarily determined according to need.

### 2. Second Embodiment

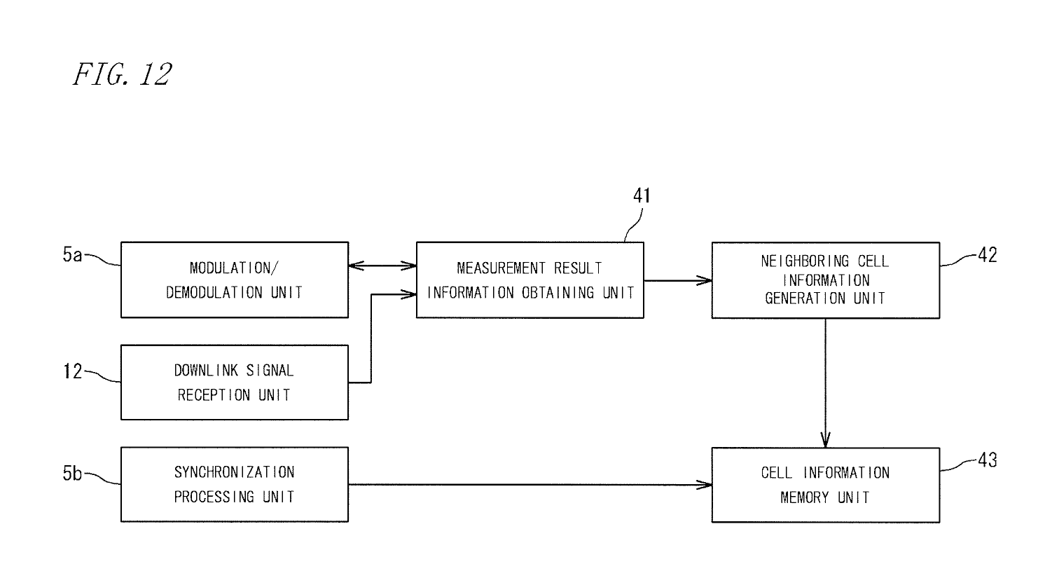

FIG. 12 is a partial block diagram showing a part of the internal configuration of a femto BS 1b according to a second embodiment of the present invention. The configuration of a macro BS 1a is substantially the same as that of the femto BS 1b.

The present embodiment is different from the first embodiment in the following points. That is, the femto BS 1b includes: a measurement result information obtaining unit 41 that obtains measurement result information indicating the result of measurement of a downlink signal of a base station device 1 other than its own base station device 1b1; a neighboring cell information generation unit 42 that generates, based on the measurement result information obtained by the measurement result information obtaining unit 41, neighboring cell information in which measurement result information of another cell (another base station device 1) neighboring on the base station device 1 is registered; and a cell information memory unit 43 that stores the generated neighboring cell information. The processing unit 5b adjusts the cycle of the synchronization process, based on the measurement result information included in the neighboring cell information.

The measurement result information obtaining unit 41 has a function of transmitting a measurement start request that causes an MS 2 communicably connected to the base station device 1b1 to execute measurement of the downlink signal of the another base station device 1, via the modulation circuit 20 and the transmission unit 13 to the MS 2.

Further, the measurement result information obtaining unit 41 has a function of obtaining measurement result information from a measurement result transmitted by the MS 2 that has performed measurement based on the measurement start request. Moreover, the measurement result information obtaining unit 41 has a function of measuring the downlink signal of the another base station device, which has been received by the second reception unit 12, and obtaining measurement result information from the measurement result.

The neighboring cell information generation unit 42 generates neighboring cell information based on the measurement result information obtained by the measurement result information obtaining unit 41, and outputs the neighboring cell information to the cell information memory unit 43. The neighboring cell information includes measurement result information such as the reception level and the carrier wave frequency of the downlink signal of the another base station device 1. More specifically, the neighboring cell information is generated as a table in which a unique cell ID given to each of other base station devices 1 is registered, and the reception level and the carrier wave frequency of the downlink signal of the another base station device 1 included in the measurement result information are associated with the cell ID of the corresponding another base station device 1.

The cell information memory unit 43 has a function of storing the neighboring cell information outputted from the neighboring cell information generation unit 42, and updating the neighboring cell information each time new neighboring cell information is outputted.

When executing the synchronization process, the synchronization processing unit 5b of the present embodiment firstly refers to the neighboring cell information stored in the cell information memory unit 43. Then, the synchronization processing unit 5b selects another base station device 1 to be a synchronization source from among other base station devices 1 registered in the neighboring cell information. Further, based on the measurement result information of the selected another base station device 1, the synchronization processing unit 5b determines a cycle to perform the synchronization process. Then, the synchronization processing unit 5b periodically performs the synchronization process by using a downlink signal of the another base station device 1 selected as a synchronization source. Note that the synchronization process is performed in a similar manner to that described for the first embodiment.

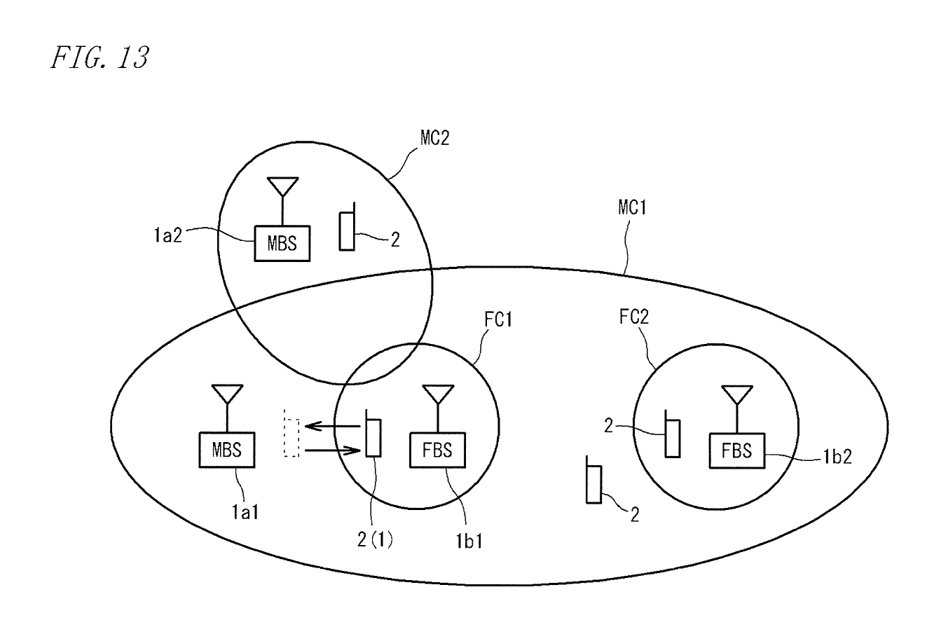

FIG. 13 is a diagram showing an example of an arrangement of the femto BS 1b according to the present embodiment in a wireless communication system. In the wireless communication system shown in FIG. 13, two macro BSs 1a1 and 1a2 and two femto BSs 1b1 and 1b2 are arranged. The femto BSs 1b1 and 1b2 form femto cells FC1 and FC2, respectively, in a macro cell MC1 formed by the macro BS 1a1. The femto cells FC1 and FC2 are formed so as not to overlap with each other. The femto cell FC1 is formed so as to overlap with a region where the macro cell MC1 and the macro cell MC2 overlap with each other.

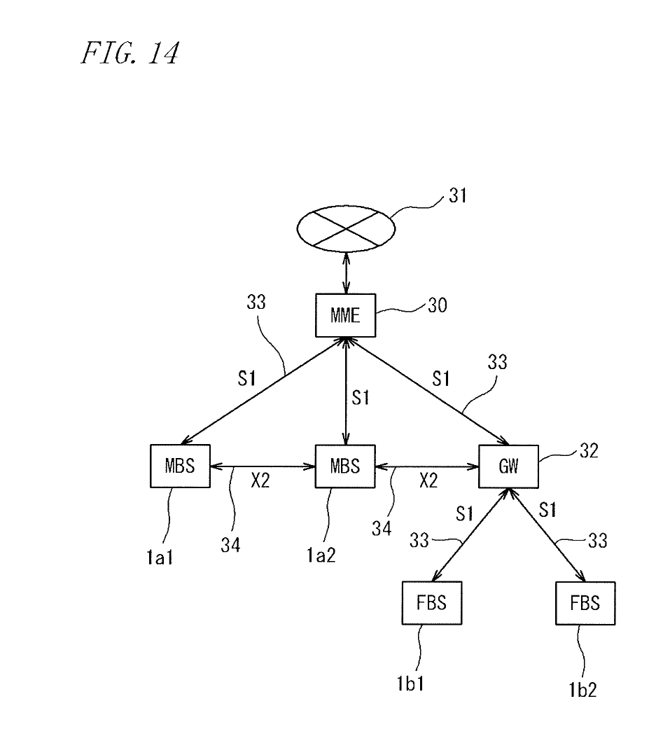

FIG. 14 is a diagram showing a manner of connection of the respective BSs to a communication network. Each macro BS 1a is connected to a communication network 31 of the wireless communication system via an MME (Mobility Management Entity) 30. The MME 30 is a node that manages the position and the like of each MS 2, and performs a process relating to mobility management for each MS2 by handover or the like.

Each femto BS 1b is connected to the MME 30 via a gateway 32 (GW). The gateway 32 has a function of relaying communication performed between each femto BS 1b and the MME 30, and communication performed between the femto BSs 1b.

Connection between the MME 30 and each macro BS 1a, connection between the MME 30 and the gateway 32, and connection between the gateway 32 and each femto BS 1b are each achieved by a line 33 of a communication interface called “S1 interface”.

Further, the macro BSs 1a are connected to each other by a line 34 of an inter-base-station communication interface called “X2 interface”, which allows inter-base-station communication for direct information exchange between the base station devices. Further, the gateway 32 is also connected to the macro BS 1a by the line 34 of the X2 interface.

The X2 interface is provided for the purpose of exchanging information relating to mobility management such as handover in each MS 2 that moves between the base station devices. Although such function overlaps with the function of the MME 30, the X2 interface for communication between the base station devices is provided for the following reasons. That is, if the MME 30 performs mobility management for all the MSs 2 connected to the respective macro BSs 1a, an enormous amount of processing concentrates on the MME 30. In addition, mobility management can be performed more efficiently among the base station devices.

A plurality of methods are considered for inter-base-station communication by the X2 interface, such as a method in which the base station devices are directly connected, and a method in which the base station devices are connected via the gateway.

As shown in FIG. 14, a direct communication line of the X2 interface is not established between the femto BS 1b and another base station device 1. Accordingly, the present embodiment adopts a method in which the femto BS 1b performs inter-base-station communication with the another base station device 1 by the X2 interface, via the communication line 33 of the S1 interface that connects the femto BS 1b to the gateway 32, and the gateway 32.

Note that, in FIG. 14, the macro BS 1a directly connected to the MME 30 may sometimes be referred to as “eNB (Evolved Node B)”, the gateway 32 as “Home-eNB Gateway”, and the femto BS 1b as “Home-eNB”.

Next, a description will be given of a manner in which the femto BS 1b of the present embodiment obtains the measurement result information to generate or update the neighboring cell information. In the following description, attention is focused on the femto BS 1b1 in FIG. 13, and its function and operation will be described.

[Obtainment of Measurement Result Information]

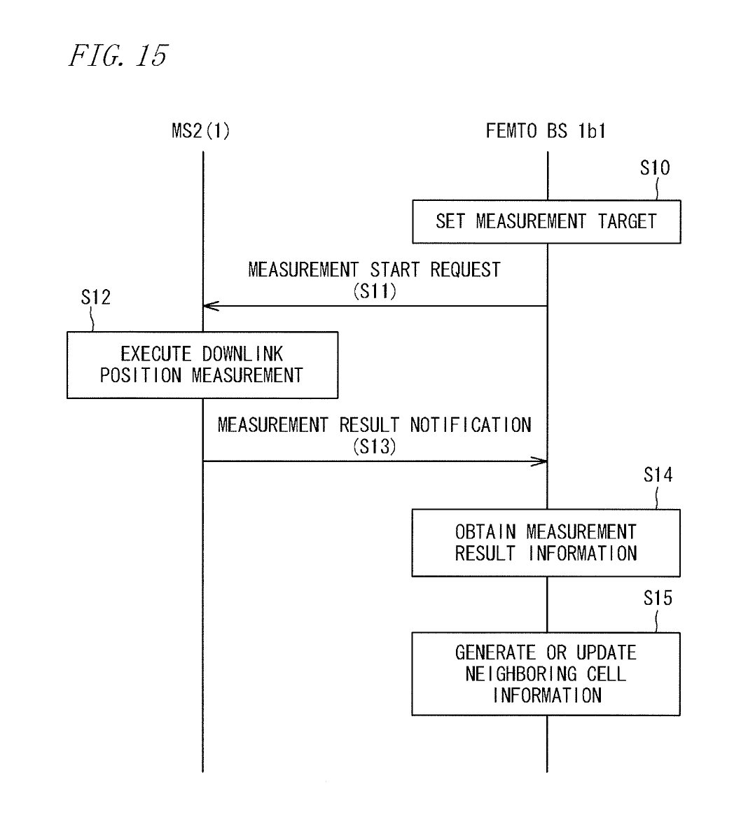

FIG. 15 is a sequential diagram showing an example of process steps when the femto BS 1b1 of the present embodiment obtains measurement result information. FIG. 15 shows a case in which the femto BS 1b1 causes the MS 2(1) to measure a downlink signal of a base station device 1 neighboring on the MS 2(1) in FIG. 13.

Firstly, the femto BS 1b1 that has determined to obtain measurement result information sets a measurement target to be measured by the MS 2(1) (step S10).

When the femto BS 1b1 does not have neighboring cell information, such as when the femto BS 1b1 is started up, the femto BS 1b1 causes the MS 2(1) to perform all-frequency search. For example, in LTE, after startup of the femto BS 1b1, when the MS 2(1) has established RRC (Radio Resource Control) connection with the femto BS 1b1, i.e., when the MS 2(1) has completed the process for establishing communication connection with the femto BS 1b1, the femto BS 1b1 causes the MS 2 to perform all-frequency search. The all-frequency search means that the reception levels of downlink signals from other base station devices 1 are measured with respect to all types (all bands) of carrier wave frequencies set in the wireless communication system.

Accordingly, when the femto BS 1b1 has no neighboring cell information, the femto BS 1b1 sets the measurement target to all frequencies, in step S10.

On the other hand, when the femto BS 1b1 has neighboring cell information, the femto BS 1b1 may set the measurement target to a downlink signal of another base station device specified by the neighboring cell information, or may set the measurement target to all frequencies, according to the situation.

Next, the femto BS 1b1 transmits, to the MS 2(1), a measurement start request that causes the MS 2(1) to measure the downlink signal of the another base station device 1 that is set as the measurement target (step S11). This measurement start request includes information of the frequency and the base station device as the measurement target.

Upon receipt of the measurement start request from the femto BS 1b1, the MS 2(1) executes downlink-signal measurement for the measurement target indicated by the measurement start request (step S12).

In step S12, the MS 2(1) detects the downlink signal of the another base station device 1, and measures the carrier wave frequency and the reception level of the detected downlink signal. Further, the MS 2(1) obtains the cell ID of the base station device 1 that is the transmission source of the detected downlink signal.

After the downlink-signal measurement, the MS 2(1) transmits, to the femto BS 1b1, measurement result notification including the carrier wave frequency of the detected downlink signal, the reception level thereof, and the corresponding cell ID (step S13).

Upon receipt of the measurement result notification from the MS 2(1), the femto BS 1b1 obtains measurement result information based on the measurement result notification (step S14).

When the femto BS 1b1 has no neighboring cell information, the femto BS 1b1 generates neighboring cell information based on the obtained measurement result information (step S15). When the femto BS 1b1 has neighboring cell information, the femto BS 1b1 updates the stored neighboring cell information based on the obtained measurement result information (step S15).

The femto BS 1b1 executes the above-mentioned process of obtaining measurement result information periodically or irregularly according to need. Further, the femto BS 1b1 executes this process also when it performs handover described later.

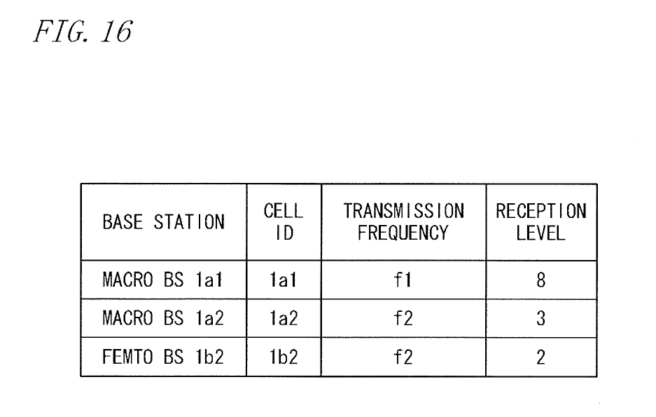

FIG. 16 is a diagram showing an example of neighboring cell information stored in the femto BS 1b1. In FIG. 16, the cell ID of the macro BS 1a1 is “1a1” and the carrier wave frequency thereof is “f1”, the cell ID of the macro BS 1a2 is “1a2” and the carrier wave frequency thereof is “f2”, and the cell ID of the femto BS 1b2 is “1b2” and the carrier wave frequency thereof is “f2”.

As shown in FIG. 16, in the neighboring cell information, the cell IDs of the detected other base station devices 1 (cells) are registered, and the carrier wave frequencies and the reception levels as the measurement result information are registered in association with the respective cell IDs.

The macro BS 1a1, the macro BS 1a2, and the femto BS 1b2 exist in the vicinity of the femto BS 1b1. Therefore, when the femto BS 1b1 performs the process of obtaining measurement result information, the MS 2(1) might detect the downlink signals from these BSs.

Accordingly, when the cell IDs of the macro BS 1a1, the macro BS 1a2, and the femto BS 1b2 are set as described above, the femto BS 1b obtains measurement result information including the cell IDs, the carrier wave frequencies, and the reception levels of these BSs.

Furthermore, the femto BS 1b1 reflects the carrier wave frequencies and the downlink signal reception levels included in the measurement result information to the neighboring cell information as shown in FIG. 16.

Here, as described above, the synchronization processing unit 5b of the femto BS 1b1 of the present embodiment selects a base station device 1 to be a synchronization source (hereinafter, also referred to as a synchronization-source base station device 1) from among the other base station devices 1 registered in the neighboring cell information. Further, the synchronization processing unit 5b determines the cycle of the synchronization process based on the measurement result information of the synchronization-source base station device 1, and performs the synchronization process periodically.

More specifically, the synchronization processing unit 5b determines the cycle of the synchronization process so as to be shorter if the reception level included in the measurement result information of the synchronization-source base station device 1 is relatively large.

That is, the closer the positions of neighboring two base station devices 1 are to each other, the higher the possibility that a downlink signal of one of the base station devices 1 causes interference to an MS 2 connected to the other base station device 1.

Further, the higher the reception level of the downlink signal of the another base station device 1, which is obtained by the femto BS 1b1 of the present embodiment, the higher the possibility that the another base station device 1 is located near the femto BS 1b1. That is, the information relating to the reception level of the another base station device 1 configures information whose value is influenced by the positional relationship between the base station device 1b1 and the another base station device 1.

For example, it is assumed that when the neighboring cell information of the femto BS 1b1 is as shown in FIG. 16, the synchronization processing unit 5b of the femto BS 1b1 selects the macro BS 1a1 as a synchronization-source base station device 1. At this time, the reception level of the macro BS 1a1 is “8” which is higher than those of the macro BS 1a2 (reception level: “3”) and the femto BS 1b2 (reception level: “2”), and therefore, the femto BS 1b1 can determine that the macro BS 1a1 is located relatively near the femto BS 1b1 and is most likely to cause interference.

Therefore, the synchronization processing unit 5b adjusts the cycle (timing) of the synchronization process to be shorter than in the case where the macro BS 1b2 or the femto BS 1b2 is selected as a synchronization-source base station device 1. Thereby, the frequency of the synchronization process is relatively increased. As a result, the accuracy of the inter-base-station synchronization is enhanced, and interference that may occur between the femto BS 1b1 and the synchronization-source base station device 1 can be effectively suppressed.

On the other hand, for example, when it is assumed that the synchronization processing unit 5b selects the macro BS 1a2 as a synchronization-source base station device 1, the femto BS 1b1 can determine, based on the reception level, that the macro BS 1a2 is located relatively far from the femto BS 1b1 and is less likely to cause interference.

In this case, the necessity of enhancing the accuracy of the inter-base-station synchronization is low, and the synchronization processing unit 5b adjusts the cycle of the synchronization process to be longer than in the case where the macro BS 1b1 is selected as a synchronization-source base station device 1. As a result, the synchronization process is avoided from being performed in vain.

As described above, according to the femto BS 1b1 of the present embodiment, the timing at which the synchronization process is performed is adjusted based on the reception level of the downlink signal from the synchronization-source base station device 1. Therefore, even when there is a possibility that interference may occur due to the relationship between the femto BS 1b1 and the synchronization-source base station device 1, the synchronization process can be performed so as to favorably avoid such interference.

[First Modification of the Second Embodiment]

In the present embodiment, the synchronization processing unit 5b adjusts the cycle of the synchronization process, based on the reception level of the downlink signal from the synchronization-source base station device 1 among the measurement results included in the neighboring cell information. However, in a modification of the present embodiment, for example, the synchronization processing unit 5b may adjust the cycle of the synchronization process, based on the carrier wave frequency of the downlink signal from the synchronization-source base station device 1, among the measurement results included in the neighboring cell information.

Specifically, when the carrier wave frequency of the synchronization-source base station device 1 is the same as the carrier wave frequency of the base station device 1b1, the synchronization processing unit 5b adjusts the cycle of the synchronization process to be shorter so that the frequency of the synchronization process is increased as compared to the case where the carrier wave frequencies are different from each other.

That is, when two base station devices 1 use different carrier wave frequencies, the possibility of interference between these base station devices 1 is low. However, when two base station devices 1 use the same carrier wave frequency, the possibility that the downlink signals of these base station devices 1 interfere with MSs 2 connected to these base station device 1, respectively, becomes high. That is, the carrier wave frequency of another base station device 1 configures information indicating whether interference can occur due to the relationship between the base station device 1b1 and the synchronization-source base station device 1.

For example, it is assumed that when the carrier wave frequency of the femto BS 1b1 is “f1” and the neighboring cell information of the femto BS 1b1 is as shown in FIG. 16, the synchronization processing unit 5b of the femto BS 1b1 selects the macro BS 1a1 as a synchronization-source base station device 1. At this time, the carrier wave frequency of the macro BS 1a1 and the carrier wave frequency of the femto BS 1b1 are both “f1”. Accordingly, the femto BS 1b1 can determine that the possibility that interference may occur due to the relationship between the femto BS 1b1 and the macro BS 1a1 is high.

Therefore, the synchronization processing unit 5b adjusts the cycle (timing) of the synchronization process to be shorter than in the case where the macro BS 1b2 whose carrier wave frequency is different from that of the femto BS 1b1 is selected. Thus, the frequency of the synchronization process is relatively enhanced. As a result, the accuracy of the inter-base-station synchronization is enhanced, and interference that may occur between the femto BS 1b1 and the synchronization-source base station device 1 can be effectively suppressed.

On the other hand, for example, it is assumed that the synchronization processing unit 5b selects the macro BS 1a2 as a synchronization-source base station device 1. In this case, since the carrier wave frequency of the macro BS 1a2 and the carrier wave frequency of the femto BS 1b1 are different from each other, the femto BS 1b1 can determine that the possibility of occurrence of interference is low.

In this case, the necessity of enhancing the accuracy of the inter-base-station synchronization is low, and the synchronization processing unit 5b adjusts the cycle of the synchronization process to be longer as compared to the case where the macro BS 1b1 is selected as a synchronization-source base station device 1.

As described above, according to the present modification, when it can be determined that interference is likely to occur because the carrier wave frequency of the base station device 1b1 is the same as that of the synchronization-source base station device 1, the synchronization processing unit 5b increases the frequency of the synchronization process as compared to the case where it can be determined that interference hardly occurs, and thus the accuracy of the inter-base-station synchronization is enhanced. As a result, it is possible to effectively suppress interference that may occur between the base station device 1b1 and the synchronization-source base station device 1.

Accordingly, also in the present modification, the accuracy of the inter-base-station synchronization can be adjusted according to need, and thus the synchronization process can be appropriately performed.

Alternatively, the measurement result information obtaining unit 41 may obtain measurement result information including the detection results of other base station devices 1, and the synchronization processing unit 5b may adjust the cycle of the synchronization process in accordance with the detection result of the synchronization-source base station device 1 obtained as the measurement result information.

[Second Modification of the Second Embodiment]

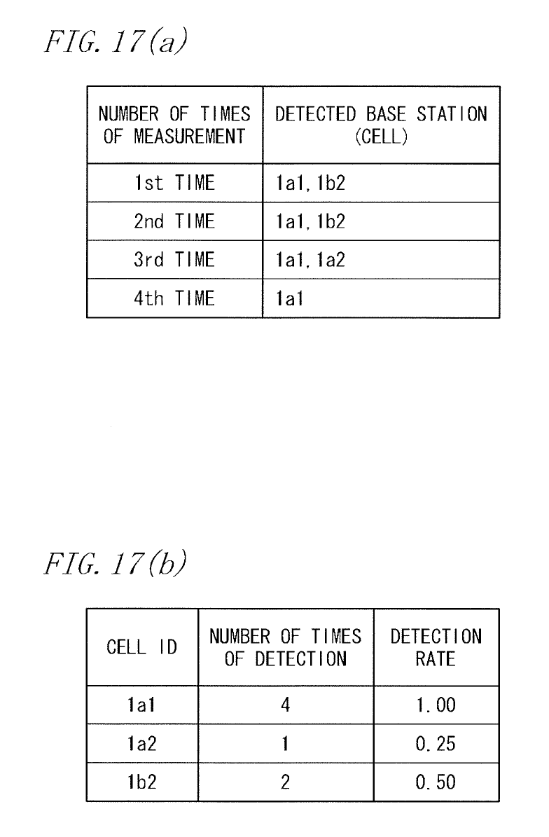

FIG. 17(a) is a diagram showing an example of a detection result of other base station devices 1 detected when a femto BS 1b according to a second modification of the second embodiment obtains measurement result information. FIG. 17(b) is a diagram showing an example of neighboring cell information generated by a neighboring cell information generation unit 42 according to the second modification, based on the detection result shown in FIG. 17(a).

The measurement result information obtaining unit 41 according to the second modification is configured to count the number of times another base station device 1 is detected, based on a measurement result notification transmitted each time an MS 2 performs downlink-signal measurement, and obtain the number of times of detection and the detection rate as measurement result information.

Further, as shown in FIG. 17(b), the neighboring cell information generation unit 42 generates neighboring cell information in which the number of times of detection and the detection rate included in the measurement result information are associated with the cell ID of the corresponding base station device 1.

Each time the measurement result information obtaining unit 41 executes obtainment of measurement result information, the measurement result information obtaining unit 41 receives, from the MS 2, a measurement result notification including the cell IDs of other base station devices 1 that are detected by downlink-signal measurement.

For example, it is assumed that the measurement result information obtaining unit 41 executes obtainment of measurement result information four times at predetermined timings, and the detection result of other base station devices 1 by the downlink-signal measurement at each execution is as shown in FIG. 17(a). In this case, in the first downlink-signal measurement, the measurement result information obtaining unit 41 receives, from the MS 2, measurement result notification including the cell IDs of the detected macro BS 1a1, macro BS 1a2, and femto BS 1b2. Similarly in the second and subsequent downlink-signal measurements, the measurement result information obtaining unit 41 receives a notification including the detection result of other base station devices 1.

The measurement result information obtaining unit 41 can recognize that the base station devices 1 corresponding to the cell IDs included in the measurement result information have been detected as the result of the downlink-signal measurement. Accordingly, each time the measurement result information obtaining unit 41 executes obtainment of measurement result information, the measurement result information obtaining unit 41 counts, for each base station device 1, the number of times the base station device 1 is detected. Further, the measurement result information obtaining unit 41 calculates, as a detection rate, the ratio of the number of times of detection to the number of times of downlink-signal measurement.

For example, as shown in FIG. 17(a), the macro BS 1a1 is detected in all the four times of downlink-signal measurement. Accordingly, the measurement result information obtaining unit 41 obtains measurement result information indicating that the number of times the macro BS 1a1 is detected is “4” and the detection rate is “1.00”. The measurement result information obtaining unit 41 obtains, for each of other detected cells, the number of times of detection and the detection rate in the same manner as described above.

The neighboring cell information generation unit 42 receives the measurement result information obtained by the measurement result information obtaining unit 41, and generates the neighboring cell information shown in FIG. 17(b).

The synchronization processing unit 5b adjusts the cycle of the synchronization process, based on at least either of the number of times the synchronization-source base station device 1 is detected, and the detection rate, which are included in the neighboring cell information.

More specifically, the synchronization processing unit 5b determines the cycle of the synchronization process to be shorter if the number of times the synchronization-source base station device 1 is detected is relatively large.

The larger the number of times of detection, the higher the possibility that the another base station device 1 corresponding to the number of times of detection is located near the base station device 1b1. That is, the number of times the another base station device 1 is detected configures information whose value is influenced by the positional relationship between the base station device 1b1 and the another base station device 1.

Further, as described above, the closer the positions of two neighboring base station devices 1 are to each other, the higher the possibility that the downlink signal of one of the base station devices 1 causes interference to an MS 2 connected to the other base station device 1.

For example, it is assumed that when the neighboring cell information of the femto BS 1b1 is as shown in FIG. 17(b), the synchronization processing unit 5b of the femto BS 1b1 selects the macro BS 1a1 as a synchronization-source base station device 1. At this time, the number of times the macro BS 1a1 is detected is “4”, which is larger than those of the macro BS 1a2 (number of times of detection: “1”) and the femto BS 1b2 (number of times of detection: “2”). Therefore, the femto BS 1b1 can determine that the macro BS 1a1 is located relatively near the femto BS 1b1 and is most likely to cause interference.

Therefore, the synchronization processing unit 5b of the femto BS 1b1, which has selected the macro BS 1a1 as a synchronization-source base station device 1, adjusts the cycle (timing) of the synchronization process to be shorter than in the case where the synchronization processing unit 5b selects the macro BS 1b2 or the femto BS 1b2 as a synchronization-source base station device 1. Thereby, the frequency of the synchronization process is relatively increased. As a result, the accuracy of the inter-base-station synchronization is enhanced, and interference that may occur between the femto BS 1b1 and the synchronization-source base station device 1 can be effectively suppressed.

On the other hand, for example, when it is assumed that the synchronization processing unit 5b selects the macro BS 1a2 as a synchronization-source base station device 1, the femto BS 1b1 can determine, based on the number of times of detection, that the macro BS 1a2 is located relatively far from the femto BS 1b1 and is less likely to cause interference.

In this case, the necessity of enhancing the accuracy of the inter-base-station synchronization is low, and the synchronization processing unit 5b adjusts the cycle of the synchronization process to be longer as compared to the case where the macro BS 1b1 is selected as a synchronization-source base station device 1. As a result, the synchronization process is avoided from being performed in vain.

As described above, according to the femto BS 1b1 of the present modification, the accuracy of the inter-base-station synchronization can be adjusted according to need. Further, even when there is a possibility that interference may occur due to the relationship with the synchronization-source base station device 1, the synchronization process can be performed so as to favorably avoid such interference.

Furthermore, like the number of times of detection, the larger the detection rate, the higher the possibility that another base station device 1 corresponding to the detection rate is located near the base station device 1b1.

Accordingly, while the above-mentioned modification illustrates the case where the synchronization processing unit 5b adjusts the cycle of the synchronization process in accordance with the number of times of detection, the synchronization processing unit 5b may adjust the cycle of the synchronization process in accordance with the detection rate included in the measurement result information of the synchronization-source base station device 1.

[Third Modification of the Second Embodiment]

According to still another modification, the measurement result information obtaining unit 41 may obtain measurement result information including the detection times at which other base station devices 1 were detected, and the synchronization processing unit 5b may adjust the cycle of the synchronization process in accordance with the detection time at which a synchronization-source base station device 1 was detected.

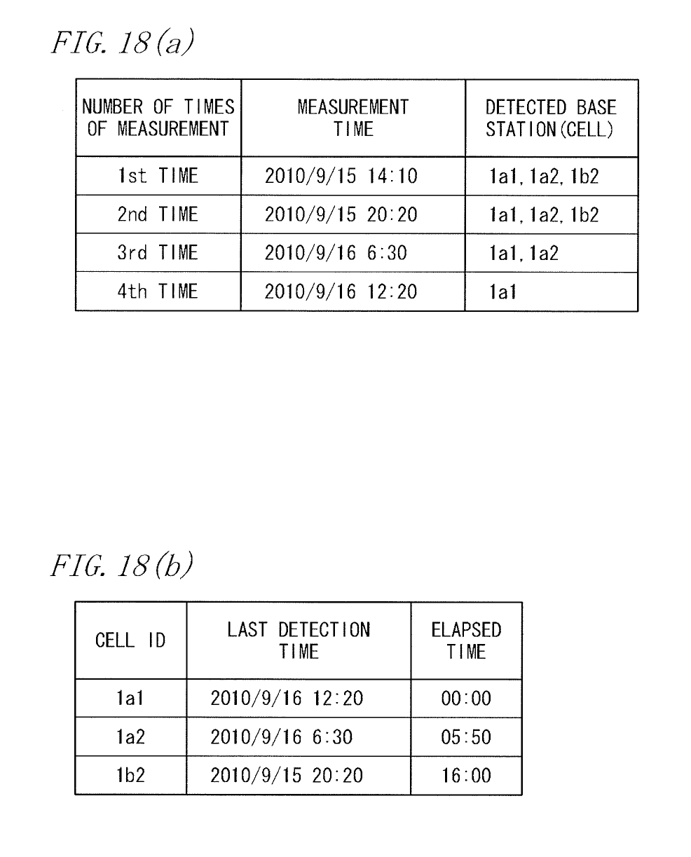

FIG. 18(a) is a diagram showing an example of a detection result of other base station devices 1 detected when a femto BS 1b according to a third modification of the second embodiment obtains the measurement result information. FIG. 18(b) is a diagram showing an example of neighboring cell information generated by the neighboring cell information generation unit 42 of this modification, based on the detection result shown in FIG. 18(a).

The measurement result information obtaining unit 41 of this modification is configured to obtain, based on a measurement result notification that is transmitted each time the MS 2 performs downlink-signal measurement, the last detection time of each of the other base station devices 1, and the elapsed time, as measurement result information.

Further, as shown in FIG. 18(b), the neighboring cell information generation unit 42 generates neighboring cell information in which the last detection times and the elapsed times included in the measurement result information are associated with the cell IDs of the corresponding other base station devices 1.

Each time the measurement result information obtaining unit 41 executes obtainment of measurement result information, the measurement result information obtaining unit 41 obtains, from the MS 2, a measurement result notification including the cell IDs of other base station devices 1 detected by downlink-signal measurement, and the measurement time at the detection.

For example, it is assumed that the measurement result information obtaining unit 41 executes obtainment of measurement result information four times at predetermined timings, and the detection result of other base station devices 1 by downlink-signal measurement at each execution is as shown in FIG. 18(a). In this case, in the first downlink-signal measurement, the measurement result information obtaining unit 41 receives, from the MS 2, a measurement result notification including the cell IDs of the detected macro BS 1a1, macro BS 1a2, and femto BS 1b2, and the measurement time at the detection, i.e., “2010/9/15 14:10”. Similarly in the second and subsequent downlink-signal measurements, the measurement result information obtaining unit 41 receives a notification including the detection result of other base station devices 1.

The measurement result information obtaining unit 41 can recognize that the base station devices 1 of the cell IDs included in the measurement result information have been detected as the result of the downlink-signal measurement. Further, the measurement result information obtaining unit 41 can also recognize the measurement time at the detection. Accordingly, each time the measurement result information obtaining unit 41 executes obtainment of measurement result information, the measurement result information obtaining unit 41 updates, for each of other base station devices 1, the last detection time at which the base station device 1 has been detected most recently. Further, the measurement result information obtaining unit 41 obtains the elapsed time from the last detection time to the present time.

For example, assuming that the present time is “2010/9/16 12:20”, the measurement time at which the macro BS 1a1 has been detected most recently is, as shown in FIG. 18(a), the same as the present time, i.e., “2010/9/16 12:20”. Accordingly, the measurement result information obtaining unit 41 obtains measurement result information indicating that the last detection time of the macro BS 1a1 is “2010/9/16 12:20”, and the elapsed time is “00:00”. The measurement result information obtaining unit 41 obtains, for each of other detected cells, the last detection time and the elapsed time in the same manner as described above.

The neighboring cell information generation unit 42 receives the measurement result information obtained by the measurement result information obtaining unit 41, and generates neighboring cell information shown in FIG. 18(b).

The synchronization processing unit 5b adjusts the cycle of the synchronization process, based on at least either of the last detection time of the synchronization-source base station device 1, and the elapsed time, which are included in the neighboring cell information.

More specifically, the shorter the elapsed time of the synchronization-source base station device 1 registered in the neighboring cell information, the shorter the synchronization processing unit 5b adjusts the cycle of the synchronization process.

The longer the elapsed time, the higher the possibility that the another base station device 1 is located relatively far from the base station device 1b1 and does not exist in the vicinity of the base station device 1b1. The reason is as follows. When the elapsed time is long, it is considered that another base station device 1 to be a target has moved away from the base station device 1b1, or is powered off and is not running.

Conversely, the shorter the elapsed time, the higher the possibility that the another base station device 1 exists in the vicinity of the base station device 1b1.

For example, it is assumed that when the neighboring cell information of the femto BS 1b1 is as shown in FIG. 18(b), the synchronization processing unit 5b of the femto BS 1b1 selects the macro BS 1a1 as a synchronization-source base station device 1. At this time, the elapsed time of the macro BS 1a1 is “0 minute”, which is shorter than those of the macro BS 1a2 (elapsed time: “5 hours and 50 minutes”) and the femto BS 1b2 (elapsed time: “16 hours”). Therefore, the femto BS 1b1 can determine that the macro BS 1a1 exists in the vicinity of the femto BS 1b1, and is highly likely to cause interference.

Therefore, the synchronization processing unit 5b adjusts the cycle (timing) of the synchronization process so as to be shorter as compared to the case where the macro BS 1b2 or the femto BS 1b2 is selected as a synchronization-source base station device 1. Thereby, the frequency of the synchronization process is relatively increased. As a result, the accuracy of the inter-base-station synchronization is enhanced, and interference that may occur between the femto BS 1b1 and the synchronization-source base station device 1 can be effectively suppressed.

On the other hand, for example, when it is assumed that the synchronization processing unit 5b selects the macro BS 1a2 as a synchronization-source base station device 1, the femto BS 1b1 can determine, based on the elapsed time, that the macro BS 1a2 is located relatively far from the femto BS 1b1, and is less likely to cause interference.

In this case, the necessity of enhancing the accuracy of the inter-base-station synchronization is low, and the synchronization processing unit 5b adjusts the cycle of the synchronization process to be longer as compared to the case where the macro BS 1b1 is selected as a synchronization-source base station device 1.

As described above, according to the present modification, the accuracy of the inter-base-station synchronization can be adjusted according to need. Further, even when there is a possibility that interference may occur due to the relationship with the synchronization-source base station device 1, the synchronization process can be performed so as to favorably avoid such interference.

While the above-mentioned modification illustrates the case where the synchronization processing unit 5b adjusts the cycle of the synchronization process in accordance with the elapsed time, the synchronization processing unit 5b may adjust the cycle in accordance with the last detection time.

[Other Modifications of the Second Embodiment]

The above-mentioned embodiment illustrates the case where the femto BS 1b causes an MS 2(1) to measure a downlink signal from another base station device 1 neighboring on the femto BS 1b to obtain the measurement result information. However, the femto BS 1b1 may cause its own downlink-signal reception unit 12 to measure a downlink signal from another base station device 1, and may obtain measurement result information from the result of the measurement.

Further, in the above-mentioned embodiment, it is determined whether the possibility that interference may occur between the base station device 1b1 and the synchronization-source base station device 1 is high, based on the reception level that is information indicating the positional relationship between the base station device 1b1 and the synchronization-source base station device 1, and then the cycle of the synchronization process is adjusted. However, if each base station device 1 is provided with a GPS function or the like and thereby can grasp its own position, the femto BS 1b1 may obtain positional information indicating the position of another base station device 1 directly from the another base station device 1, and may adjust the cycle of the synchronization process, based on the positional information.

In this case, since the respective base station devices 1 can perform inter-base-station communication via the X2 interface, the femto BS 1b1 can obtain the positional information of each base station device 1 by the inter-base-station communication.

Further, when the respective base station devices 1 are allowed to perform inter-base-station communication via the X2 interface, the base station devices 1 can easily exchange information such as their positions and carrier wave frequencies, and therefore, can favorably perform the process for avoiding interference.

Accordingly, the base station device 1b1 may obtain, from another base station device 1, information indicating whether the base station device 1b1 and the another base station device 1 are allowed to perform inter-base-station communication via the X2 interface, and may generate neighboring cell information in which this information is registered.

In this case, if the synchronization processing unit 5b of the femto BS 1b1 selects, as a synchronization source, another base station device 1 capable of performing inter-base-station communication via the X2 interface with the base station device 1b1, the synchronization processing unit 5b adjusts the cycle of the synchronization process to be shorter as compared to the case where another base station device 1 incapable of performing inter-base-station communication is selected. Thereby, if the femto BS 1b1 can favorably perform the process for avoiding interference with the synchronization-source base station, the femto BS 1b1 adjusts the cycle of the synchronization process to be relatively shorter, and thus can effectively perform the process for avoiding interference.

In this way, the information indicating whether inter-base-station communication via the X2 interface can be performed between the base station device 1b1 and another base station device 1 configures information indicating whether it is possible to avoid interference that may occur due to the relationship between the base station device 1b1 and the another base station device 1.

### 3. Third Embodiment

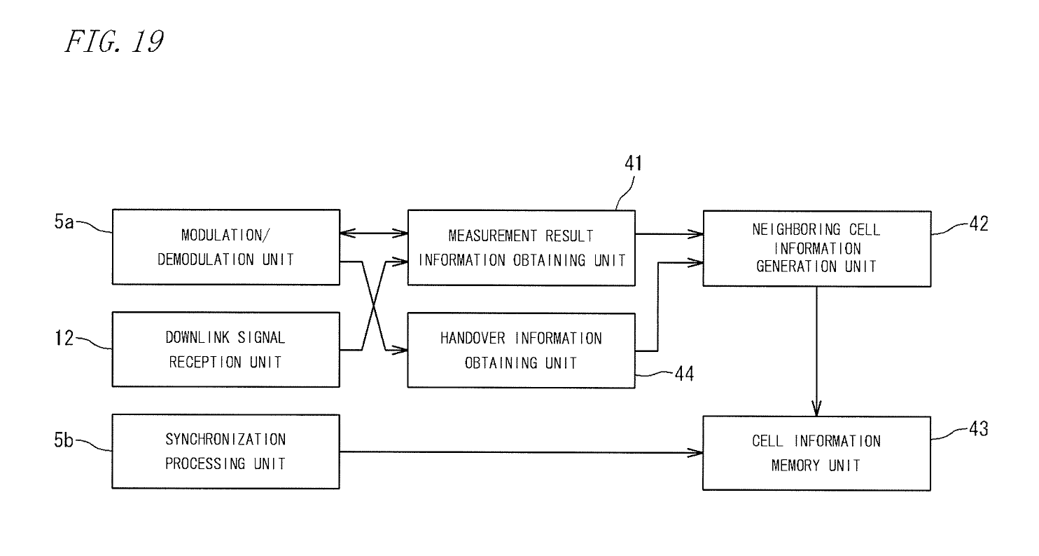

FIG. 19 is a partial block diagram showing a part of an internal configuration of a femto BS 1b according to a third embodiment of the present invention. The configuration of a macro BS 1a is substantially the same as that of the femto BS 1b.

The present embodiment is different from the second embodiment in the following points. That is, the femto BS 1b1 includes a handover information obtaining unit 44 that obtains handover information relating to handover performed by an MS 2 that is communicably connected to the femto BS 1b1. The neighboring cell information generation unit 42 generates and updates neighboring cell information in which the handover information is associated with a cell ID of another base station device 1 as a handover target. The synchronization processing unit 5b adjusts the cycle of the synchronization process in accordance with the handover information.

The handover information includes the number of trials of handover, the number of successes of handover, and the handover success rate, which are obtained when the MS 2 connected to the femto BS 1b1 performs handover.

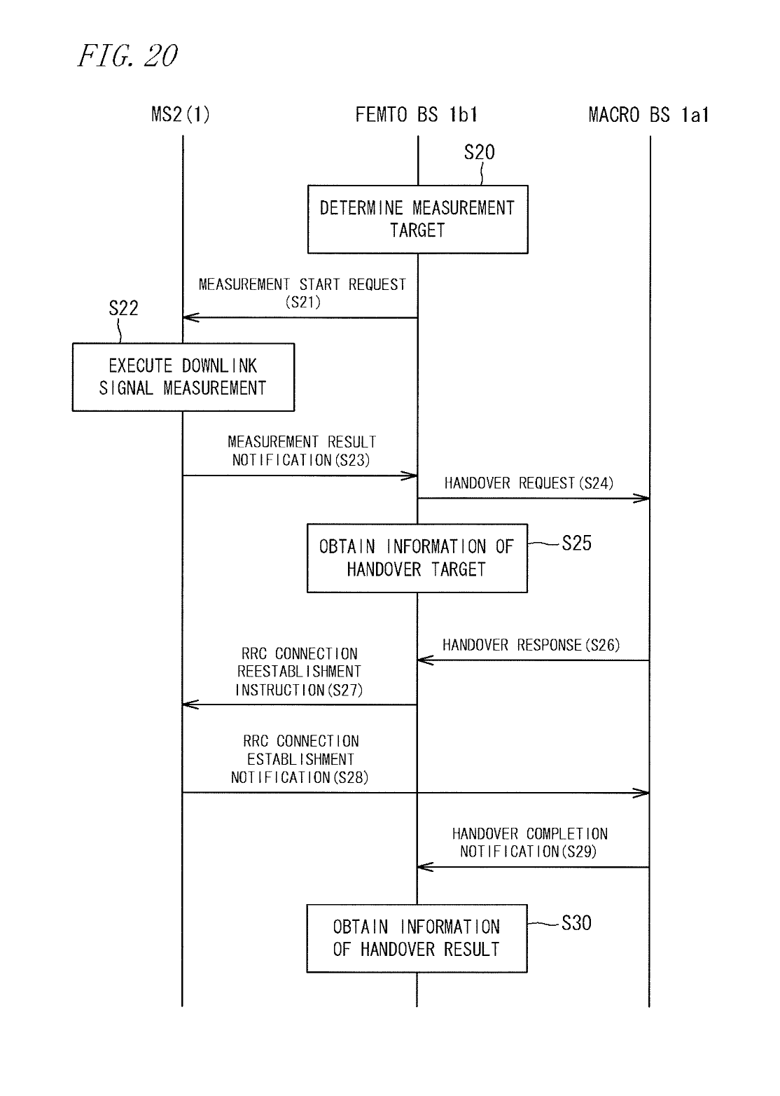

FIG. 20 is a sequential diagram showing an example of a manner in which the femto BS 1b1 obtains handover information during handover performed between the femto BS 1b1 and the MS 2. Note that FIG. 20 shows a case where the MS 2(1) connected to the femto BS 1b1 in FIG. 13 performs handover to the macro BS 1a1.

Firstly, the femto BS 1b1 executes obtainment of measurement result information to cause the MS 2(1) to perform downlink-signal measurement. Therefore, the femto BS 1b1 sets a measurement target of the MS 2(1) (step S20). Here, the femto BS 1b1 sets the measurement target to a downlink signal of another base station device 1 registered in the neighboring cell information.

Next, the femto BS 1b1 transmits, to the MS 2(1), a measurement start request that causes the MS 2(1) to measure the downlink signal as the set measurement target (step S21). The measurement start request includes information of the frequency and the base station device as the measurement target, and the like.

Next, the MS 2(1) receives the measurement start request from the femto BS 1b1, and executes downlink-signal measurement for the measurement target indicated by the measurement start request (step S22).

Upon completion of the downlink-signal measurement, the MS 2(1) transmits, as a measurement result, to the femto BS 1b1, a measurement result notification including the reception level of the detected downlink signal and the corresponding cell ID (step S23). Further, at this time, the MS 2(1) also transmits, to the femto BS 1b1, the reception level of the downlink signal of the femto BS 1b1.

Upon receipt of the measurement result notification from the MS 2(1), the femto BS 1b1 determines, based on the measurement result notification, whether the MS 2(1) should perform handover. Upon determination that the MS 2(1) should perform handover, the femto BS 1b1 determines a handover target with reference to the neighboring cell information, and transmits a handover request to the macro BS 1a1 (step S24). In FIG. 20, the macro BS 1a1 is determined as the handover target.

The determination whether to perform handover and the determination of the handover target are performed by comparing the reception level of the downlink signal of the currently-connected base station device 1 with the reception level of the another base station device 1.

Furthermore, the determination whether to perform handover and the determination of the handover target may be performed by the MS 2(1). In this case, the femto BS 1b1 transmits a handover request in accordance with the determinations by the MS 2(1).

By transmitting the handover request, the femto BS 1b1 can recognize to which base station device 1 the MS 2(1) has tried handover. Here, the handover information obtaining unit 44 is informed that the MS 2(1) has tried handover, and obtains information relating to the determined handover target (step S25).

Upon receipt of the handover request, the macro BS 1a1 transmits, to the femto BS 1b1, a handover response to the handover request (step S26).

Upon receipt of the handover response, the femto BS 1b1 transmits an RRC connection reestablishment instruction to the MS 2(1) (step S27).

When an RRC connection has been established between the MS 2(1) and the macro BS 1a1, the MS 2(1) transmits an RRC connection establishment notification to the macro BS 1a1 (step S28).

Upon receipt of the RRC connection establishment notification, the macro BS 1a1 transmits a handover completion notification to the femto BS 1b1 (step S29).

Upon receipt of the handover completion notification, the femto BS 1b1 releases the information relating to the MS 2(1), and ends the handover. Further, by receiving the handover completion notification, the femto BS 1b1 can recognize that the handover has succeeded. At this time, the handover information obtaining unit 44 obtains information relating to the result of the handover (step S30).

If the handover has failed, the macro BS 1a1 transmits a handover failure notification in step S29.

The transmission/reception of the handover request, the handover response, and the handover completion notification between the femto BS 1b1 and the macro BS 1a1 are performed via a superordinate device such as the MME 30 and the gateway 32, but may be performed by inter-base-station communication via the X2 interface.

Based on the information that handover has been tried, the information relating to the determined handover target, and the information relating to the handover result, which have been obtained in steps S25 and S30, the handover information obtaining unit 44 obtains the number of trials of handover, the number of successes of handover, and the handover success rate, which are handover information of each another base station device 1. The handover success rate is obtained by dividing the number of successes of handover by the number of trials of handover.

The handover information obtaining unit 44 outputs the obtained handover information to the neighboring cell information generation unit 42. Based on the handover information, the neighboring cell information generation unit 42 generates and updates neighboring cell information in which the number of trials of handover, the number of successes of handover, and the handover success rate, which are included in the handover information, are associated with the cell ID of the another base station device 1 as a handover target.

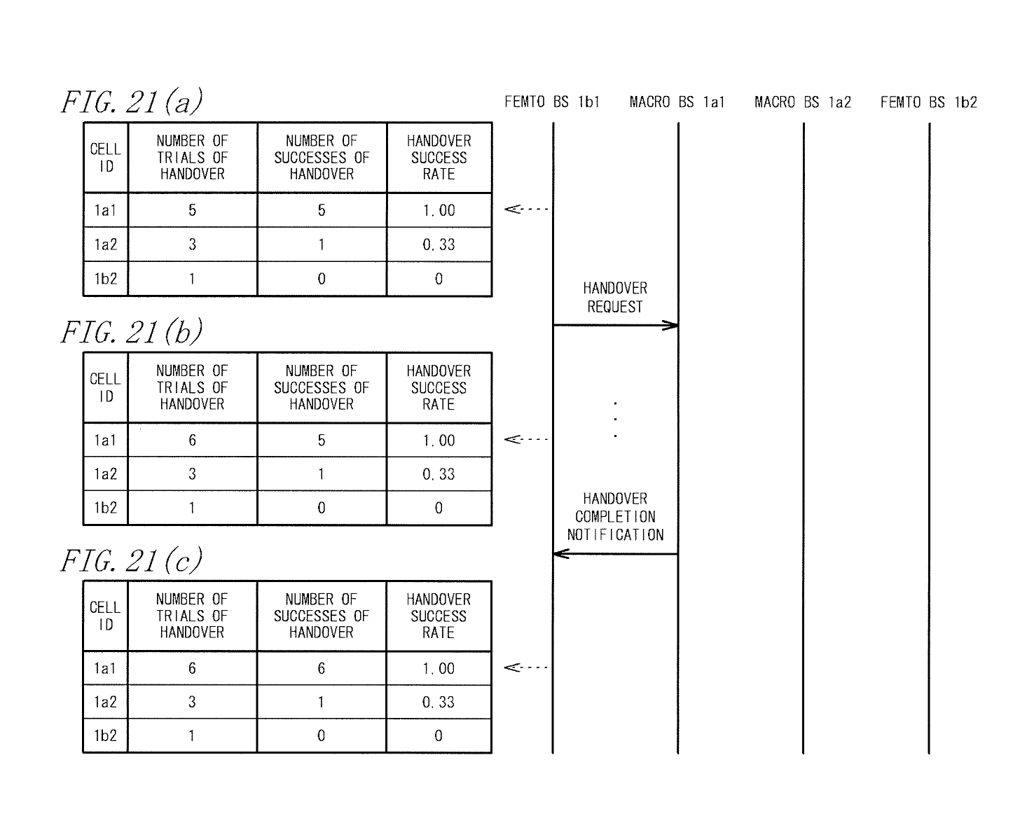

FIG. 21 is a diagram showing an example of a manner in which the femto BS 1b1 updates the neighboring cell information when handover has been performed in the procedure shown in FIG. 20. In FIG. 21, a sequential diagram of a handover operation process is shown on the right, and neighboring cell information corresponding to the handover operation process is shown on the left.

In FIG. 21, in the stage before the femto BS 1b1 transmits a handover request to the macro BS 1a1 (FIG. 21(a)), the femto BS 1b1 has tried handover nine times in a predetermined time period. That is, the neighboring cell information of the femto BS 1b1 in this stage indicates that handover from the femto BS 1b1 to the macro BS 1a1 has been tried five times in the past and the five trials have succeeded. Therefore, the handover success rate is “1.00”. Further, the neighboring cell information indicates that handover from the femto BS 1b1 to the macro BS 1a2 has been tried three times and one trial has succeeded. Therefore, the handover success rate is “0.33”. Further, the neighboring cell information indicates that handover from the femto BS 1b1 to the femto BS 1b2 has been tried three times and one trial has succeeded. Therefore, the handover success rate is “0.33”.

It is assumed that, from the above state, the femto BS 1b1 tries handover to the macro BS 1a1 as a handover target, for the MS 2(1) connected to the femto BS 1b1.

After transmitting a handover request to the macro BS 1a1, the femto BS 1b1 updates the number of trials of handover to the macro BS 1a1, in the neighboring cell information, from “5” to “6” (FIG. 21(b)).

Upon receipt of a handover completion notification from the macro BS 1a1, the femto BS 1b1 updates the number of successes of handover to the macro BS 1a1, in the neighboring cell information, from “5” to “6” (FIG. 21(c)). In this case, the handover success rate does not change and remains as it is.

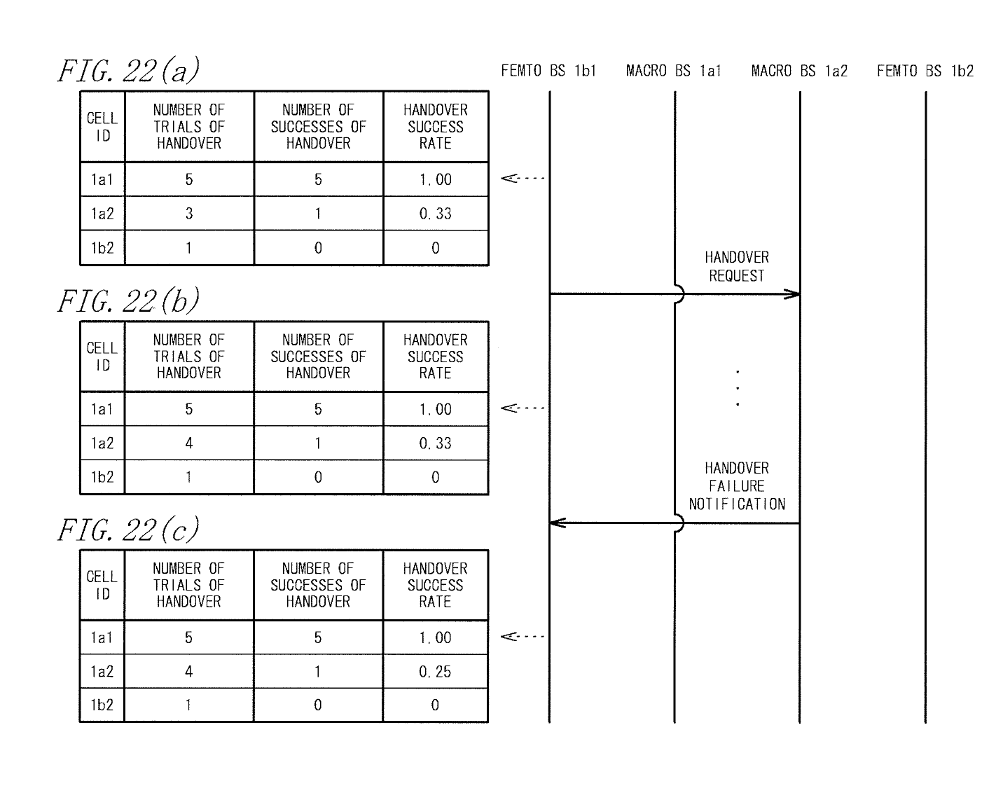

FIG. 22 is a diagram showing another example of a manner in which the femto BS 1b1 updates the neighboring cell information when handover has been performed.

In FIG. 22, in the stage before the femto BS 1b1 transmits a handover request (FIG. 22(a)), the contents of the neighboring cell information is the same as that shown in FIG. 21.

It is assumed that, from this state, the femto BS 1b1 tries handover to the macro BS 1a2 as a handover target, for the MS 2(1) connected to the femto BS 1b1.

After transmitting a handover request to the macro BS 1a2, the femto BS 1b1 updates the number of trials of handover to the macro BS 1a2, in the neighboring cell information, from “3” to “4” (FIG. 22(b)).

If the requested handover has failed, the femto BS 1b1 receives a handover failure notification from the macro BS 1a2. Thereby, the femto BS 1b1 maintains, in the neighboring cell information, the number of successes of handover to the macro BS 1a2 to be “1”, and updates the handover success rate from “0.33” to “0.25” (FIG. 22(c)).

If the femto BS 1b1 can recognize the handover source, the femto BS 1b1 may generate neighboring cell information by using not the information of the handover target but the information of the handover source.

Here, as described above, the synchronization processing unit 5b of the femto BS 1b1 according to the present embodiment adjusts the cycle of the synchronization process, based on the handover information.

More specifically, the synchronization processing unit 5b adjusts the cycle of the synchronization process to be shorter, when the number of trials of handover is relatively large in the handover information.

The larger the number of trials of handover, the higher the possibility that the another base station device 1 corresponding to the number of trials of handover is located near the base station device 1b1. That is, the MS 2 connected to the base station device 1b1 is determined to be highly likely to need handover, when the reception level of the another base station device 1 neighboring on the base station device 1b1 is relatively high. The reception level, when it is relatively high, indicates that the another base station device 1 is highly likely to exist near the femto BS 1b1. That is, the number of trials of handover of the MS 2 performed to the another base station device 1 configures information whose value is influenced by the positional relationship between the base station device 1b1 and the another base station device 1.

Further, the closer the positions of neighboring two base station devices are to each other, the higher the possibility that a downlink signal of one of the base station devices 1 causes interference to an MS 2 connected to the other base station device 1.

For example, it is assumed that when the neighboring cell information of the femto BS 1b1 is as shown in FIG. 21(c), the synchronization processing unit 5b of the femto BS 1b1 selects the macro BS 1a1 as a synchronization-source base station device 1. At this time, the number of trials of handover of the macro BS 1a1 is “6”, which is larger than those of the macro BS 1a2 (number of trials of handover: “3”) and the femto BS 1b2 (number of trials of handover: “1”). Therefore, the femto BS 1b1 can determine that the macro BS 1a1 is located relatively near the femto BS 1b1, and is highly likely to cause interference.

Therefore, the synchronization processing unit 5b adjusts the cycle (timing) of the synchronization process to be shorter as compared to the case where the macro BS 1b2 or the femto BS 1b2 is selected as a synchronization-source base station device 1. Thereby, the frequency of the synchronization process is relatively enhanced. As a result, the accuracy of the inter-base-station synchronization is enhanced, and interference that may occur between the femto BS 1b1 and the synchronization-source base station device 1 can be effectively suppressed.

On the other hand, for example, when it is assumed that the synchronization processing unit 5b selects the macro BS 1a2 as a synchronization-source base station device 1, the femto BS 1b1 can determine, based on the number of trials of handover, that the macro BS 1a2 is located relatively far from the femto BS 1b1 and is less likely to cause interference.

In this case, the necessity of enhancing the accuracy of the inter-base-station synchronization is low, and the synchronization processing unit 5b adjusts the cycle of the synchronization process to be longer as compared to the case where the macro BS 1b1 is selected as a synchronization-source base station device 1.

As described above, according to the present embodiment, the accuracy of the inter-base-station synchronization can be adjusted according to need. Further, even when there is a possibility that interference may occur due to the relationship with the synchronization-source base station device 1, the synchronization process can be performed so as to favorably avoid such interference.

While the femto BS 1b1 of the present embodiment adjusts the cycle of the synchronization process based on only the number of trials of handover, the femto BS 1b1 may adjust the cycle of the synchronization process in view of the number of successes of handover or the handover success rate in addition to the number of trials of handover.

Further, if the handover information obtaining unit 44 can obtain the time interval between handover trials (handover interval) of each another base station device 1, the cycle of the synchronization process may be adjusted in accordance with the handover interval. The reason is as follows. The shorter the handover interval, the larger the number of trials of handover per unit time.

[Modifications of the Third Embodiment]

As the information whose value is influenced by the positional relationship between the base station device 1b1 and another base station device 1, a sojourn time (an average value or the like) during which an MS 2 connected to the base station device 1b1 stays in the cell of the base station device 1b1 may be used in addition to the number of trials of handover, the number of successes of handover, or the handover success rate. The sojourn time is a time interval (t2−t1) from time t1 at which handover has been performed to connect the MS 2 to the base station device 1b1 to time t2 at which handover is performed to connect the MS 2 to another base station device 1. The shorter the sojourn time, the more frequently handover is performed. So, the brevity of the sojourn time serves as an index similar to the frequency of handover. That is, the sojourn time is information whose value is influenced by the number of times of handover.

The sojourn time may be a time during which an MS 2 stays in another cell neighboring on the cell of the base station device 1b1. That is, the sojourn time may be a time interval from time t1 at which handover has been performed to change connection of the MS 2 from the base station device 1b1 to first another base station device 1, to time t2 at which handover is performed to change connection of the MS 2 from the first another base station device 1 to second another base station device 1 or the base station device 1b1 (i.e., the sojourn time in the cell of the first another base station device 1).

Alternatively, the sojourn time may be a time interval from time t1 at which handover has been performed to change connection of the MS 2 from the first another base station device 1 to the second another base station device 1, to time t2 at which handover is performed to change connection of the MS 2 from the first another base station device 1 to the base station device 1b1 (i.e., the sojourn time in the cell of the second another base station device 1).

### 4. Fourth Embodiment

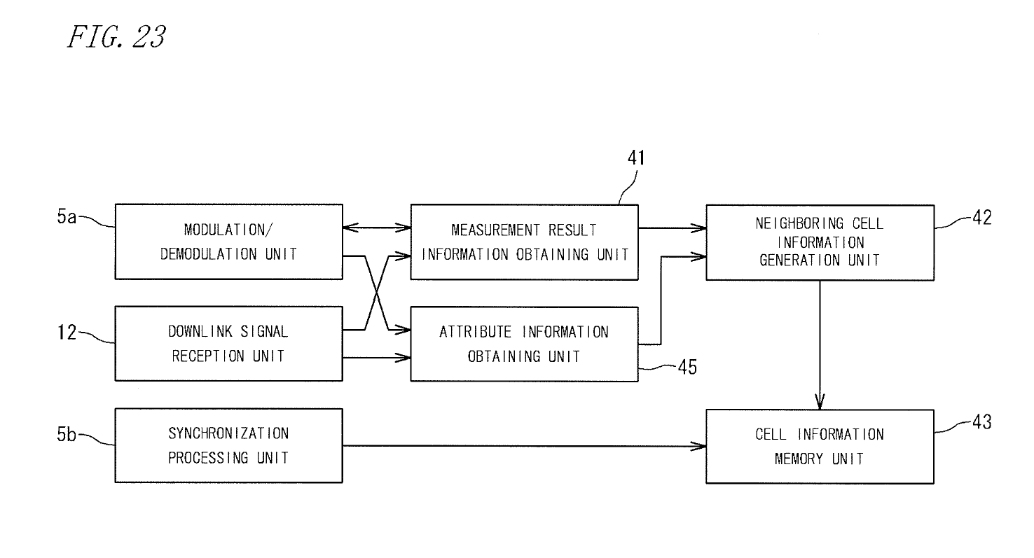

FIG. 23 is a partial block diagram showing a part of an internal configuration of a femto BS 1b according to a fourth embodiment of the present invention. The configuration of a macro BS 1a is substantially the same as that of the femto BS 1b.

The present embodiment is different from the second embodiment in the following points. That is, the femto BS 1b1 includes an attribute information obtaining unit 45 that obtains attribute information indicating an attribute relating to communication connection with another base station device 1. The neighboring cell information generation unit 42 generates and updates neighboring cell information in which the attribute information is associated with the cell ID of the corresponding another base station device 1. The synchronization processing unit 5b adjusts the cycle of the synchronization process in accordance with the attribute information.

The attribute information obtaining unit 45 receives a downlink signal received from another base station device 1 by the downlink signal reception unit 12, or a measurement result notification transmitted from an MS 2 connected to the base station device 1b1 that has obtained measurement result information, and obtains attribute information based on the information included in the downlink signal, or the measurement result notification. The attribute information includes access mode information indicating an access mode in which the another base station device 1 is set, information relating to the cell type for identifying whether the another base station device 1 is a macro base station or a femto base station, and information indicating the resource block allocation scheme adopted by the another base station device 1.

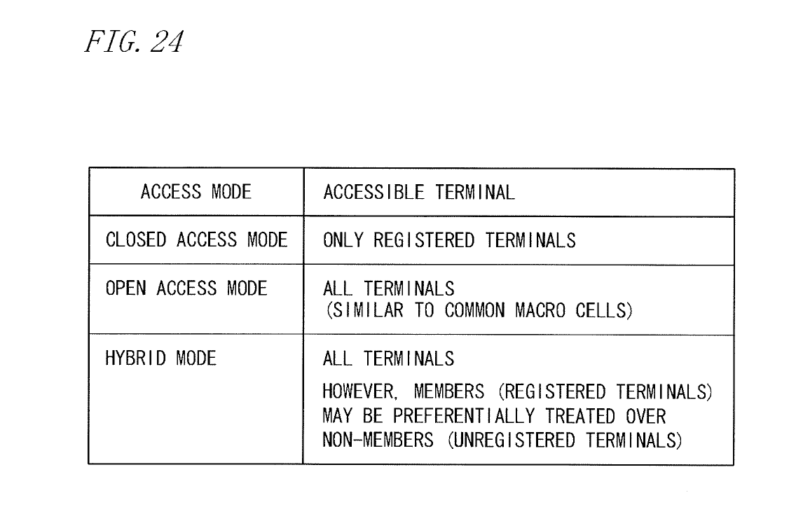

FIG. 24 is a diagram showing access modes in which base station devices 1 are set.

An access mode is a mode that defines a restriction on communication access between a base station device and an MS 2. As shown in FIG. 24, there are three types of access modes, an open access mode, a closed access mode, and a hybrid mode. Each base station device 1 is set in any of these three types of access modes.

The open access mode is a mode in which all MSs 2 are allowed to access. Since a macro BS 1a installed by a telecommunications carrier or the like is highly public, it is usually set in the open access mode.

The closed access mode is a mode in which only MSs 2 registered in a base station device 1 set in this mode are allowed to access.

The hybrid mode is a mode in which all MSs 2 are fundamentally allowed to access, but a registered MS 2 may be treated preferentially in communication resource allocation or the like over an unregistered terminal device.

A femto BS 1b is set in any one of the above-mentioned three modes.

A femto BS 1b is installed by an individual or a company in its own building or a specific space, and the individual or the company that installs the femto BS 1b may desire to limit MSs 2 that are allowed to access the femto BS 1b. In this case, the femto BS 1b is configured to be able to select any one of the above-mentioned three modes in accordance with the situation.

Meanwhile, there are two types of resource block allocation schemes, distributed transmission and localized transmission. The distributed transmission is a scheme in which the resources of respective MSs 2 are evenly distributed over a predetermined frequency band width, and transmitted. The localized transmission is a scheme in which the resources of respective MSs 2 are allocated to resource blocks that are continuous in the frequency direction within ranges of specific frequency band widths, respectively, and the resource of an MS 2 is transmitted in a range of a predetermined narrow band.

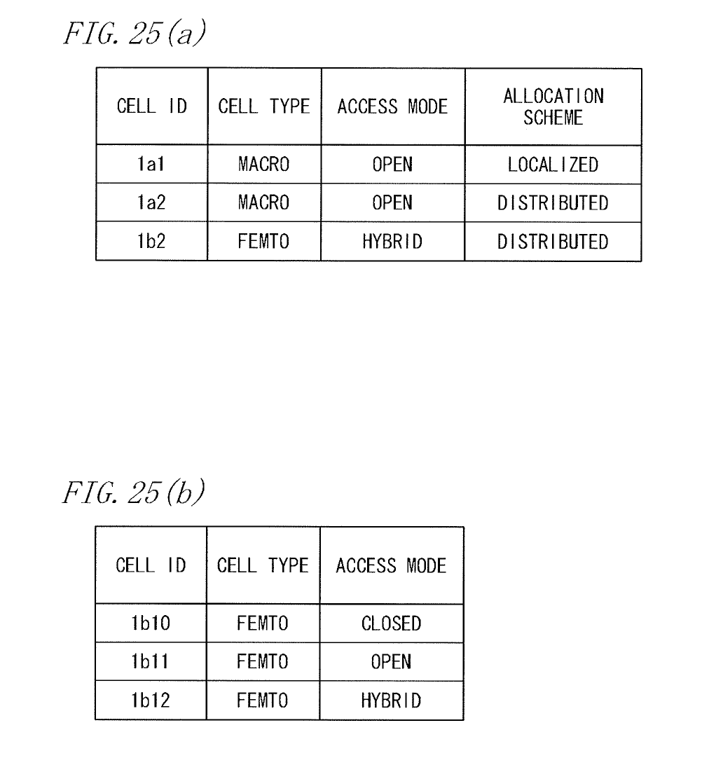

FIG. 25(a) is a diagram showing an example of neighboring cell information generated by the femto BS 1b1 according to the present embodiment.

For example, assuming that the femto BS 1b2 shown in FIG. 13 is set in the hybrid mode, the attribute information obtaining unit 45 obtains access mode information indicating that the femto BS 1b2 is in the hybrid mode. On the other hand, the macro BS 1a1 and the macro BS 1a2 shown in FIG. 13 are set in the open access mode. Accordingly, the attribute information obtaining unit 45 obtains access mode information indicating that the macro BS 1a1 and the macro BS 1a2 are in the open access mode.

The neighboring cell information generation unit 42 associates the access mode information, the information relating to the cell type, and the information indicating the resource block allocation scheme adopted by the another base station device 1 with the corresponding cell ID, thereby generating neighboring cell information shown in FIG. 25(a).

The synchronization processing unit 5b adjusts the cycle of the synchronization process, based on the attribute information of the synchronization-source base station device 1, which is included in the neighboring cell information.

More specifically, when the synchronization-source base station device 1 is set in the open access mode, the synchronization processing unit 5b adjusts the cycle of the synchronization process to be shorter than in the case where the synchronization-source base station device 1 is set in the other modes. Subsequently, the synchronization processing unit 5b adjusts the cycle of the synchronization process so as to be longer in order of the hybrid mode, and the closed access mode.

Among the above-mentioned access modes, the open access mode in which all MSs 2 are allowed to access is most public, and there is a high possibility that many MSs 2 are connected. On the other hand, the closed access mode is least public, and relatively less number of MSs 2 are connected.

Since the femto BS 1b1 is likely to interfere with MSs 2 connected to another base station device 1, if many MSs 2 are connected to the another base station device 1, the possibility of interference is increased.

For example, it is assumed that when the neighboring cell information of the femto BS 1b1 is as shown in FIG. 25(a), the synchronization processing unit 5b of the femto BS 1b1 selects the macro BS 1a1 as a synchronization-source base station device 1. At this time, since the access mode of the macro BS 1a1 is “open”, the femto BS 1b1 can determine that the possibility of occurrence of interference is high.

Therefore, the synchronization processing unit 5b adjusts the cycle (timing) of the synchronization process to be shorter than in the case where the femto BS 1b2 whose access mode is “hybrid” is selected as a synchronization-source base station device 1. Thereby, the frequency of the synchronization process is relatively increased. As a result, the accuracy of the inter-base-station synchronization is enhanced, and interference that may occur between the femto BS 1b1 and the synchronization-source base station device 1 can be effectively suppressed.

Further, it is assumed that when the neighboring cell information of the femto BS 1b1 is as shown in FIG. 25(b), the synchronization processing unit 5b of the femto BS 1b1 selects the femto BS 1b10 as a synchronization-source base station device 1. At this time, since the access mode of the femto BS 1b10 is “closed”, the femto BS 1b1 can determine that the possibility of occurrence of interference is low.

In this case, the necessity of enhancing the accuracy of the inter-base-station synchronization is low, and therefore, the synchronization processing unit 5b adjusts the cycle (timing) of the synchronization process to be longer than in the case where the femto BS 1b11 (open access mode) or the femto BS 1b12 (hybrid mode) is selected as a synchronization-source base station device 1. Thereby, the frequency of the synchronization process can be relatively reduced, and thus the synchronization process is avoided from being performed in vain.

It is assumed that when the neighboring cell information of the femto BS 1b1 is as shown in FIG. 25(b), the synchronization processing unit 5b of the femto BS 1b1 selects the femto BS 1b12 as a synchronization-source base station device 1. Since the access mode of the femto BS 1b12 is “hybrid”, the femto BS 1b1 can determine that the possibility of occurrence of interference is higher than in the case where the femto BS 1b10 is selected, but is lower than in the case where the femto BS 1b11 is selected.

In this case, the synchronization processing unit 5b adjusts the cycle of the synchronization process to be longer than in the case where the femto BS 1b11 (open access mode) is selected as a synchronization-source base station device 1, and shorter than in the case where the femto BS 1b10 (closed access mode) is selected as a synchronization-source base station device 1.

In this way, the synchronization processing unit 5b can adjust the accuracy of the inter-base-station synchronization in accordance with the access mode, and even if there is a possibility that interference may occur due to the relationship with the synchronization-source base station device 1, the synchronization processing unit 5b can perform the synchronization process so as to favorably avoid such interference.

While the above-mentioned embodiment illustrates the case where the access mode is used as the attribute information, the cycle of the synchronization process may be adjusted based on information relating to the cell type for identifying whether another base station 1 is a macro base station or a femto base station. The reason is as follows. Since the macro BS 1a is highly public as described above, the accuracy of the inter-base-station synchronization must be enhanced more in the case where the macro BS 1a is selected as a synchronization source than in the case where the femto BS 1b is selected as a synchronization source.

Accordingly, the synchronization processing unit 5b adjusts the cycle of the synchronization process to be shorter in the case where the macro BS 1a is selected as a synchronization-source base station device 1 than in the case where the femto BS 1b is selected as a synchronization-source base station device 1.

Note that the information relating to the cell type for identifying whether another base station device 1 is a macro base station or a femto base station, includes information indicating the transmission power of a downlink signal, in addition to the information directly indicating a macro base station or a femto base station. The transmission power of a downlink signal from a macro base station is set to a value significantly greater than that of a femto base station that forms a narrow femto cell FC. Therefore, it is possible to determine whether another base station device 1 is a macro base station or a femto base station, by referring to information indicating the transmission power of the downlink signal.

That is, when the transmission power of the downlink signal is relatively small to the extent that allows formation of a narrow cell, it is determined that the transmission source of the downlink signal is a femto base station. On the other hand, when the transmission power of the downlink signal is sufficiently large to the extent that allows formation of a wide cell, it is determined that the transmission source of the downlink signal is a macro base station. Accordingly, the larger the transmission power of the downlink signal, the shorter the cycle of the synchronization process may be adjusted. The smaller the transmission power of the downlink signal, the longer the cycle of the synchronization process may be adjusted.

Further, the cycle of the synchronization process may be adjusted based on the resource block allocation scheme adopted by the synchronization-source base station device 1.

In this case, it is preferable that the synchronization processing unit 5b adjusts the cycle of the synchronization process to be longer so that the frequency of the synchronization process becomes lower in the case where the allocation scheme of the synchronization-source base station device 1 is “distributed” than in the case where it is “localized”.

When the allocation scheme is “localized”, the resource of each MS 2 is allocated to a range of a specific frequency band width, as described above. Accordingly, in order to suppress interference between the base station device 1b1 and another base station device 1, the resources of the respective MSs 2 can be allocated so as not to overlap each other in the frequency direction.

On the other hand, when the allocation scheme is “distributed”, the resources of the respective MSs 2 are evenly distributed over a predetermined frequency band width, and transmitted. Therefore, it is difficult to allocate the resources so as not to overlap each other between the base station device 1b1 and the another base station device 1. Accordingly, by adjusting the cycle of the synchronization process to be longer, the synchronization process is avoided from being performed in vain.

That is, the information indicating the allocation scheme configures information indicating whether interference between the base station device 1b1 and another base station device 1 is avoidable.

For example, it is assumed that when the neighboring cell information of the femto BS 1b1 is as shown in FIG. 25(a), the synchronization processing unit 5b of the femto BS 1b1 selects the macro BS 1a1 as a synchronization-source base station device 1. At this time, since the allocation scheme of the macro BS 1a1 is “localized”, the femto BS 1b1 can determine that it is possible to avoid interference between the femto BS 1b1 and the macro BS 1a1.

Therefore, the synchronization processing unit 5b adjusts the cycle (timing) of the synchronization process to be shorter than in the case where the macro BS 1a2 whose allocation scheme is “distributed” is selected as a synchronization-source base station device 1. Thereby, the frequency of the synchronization process is relatively increased. As a result, the accuracy of the inter-base-station synchronization is enhanced, and interference that may occur between the femto BS 1b1 and the synchronization-source base station device 1 can be effectively suppressed.

On the other hand, when it is assumed that the synchronization processing unit 5b selects the macro BS 1a2 as a synchronization-source base station device 1, the femto BS 1b1 can determine, based on the allocation scheme, that it is difficult to avoid interference between the femto BS 1b1 and the macro BS 1a2.

In this case, the necessity of enhancing the accuracy of the inter-base-station synchronization is low, and therefore, the synchronization processing unit 5b adjusts the cycle of the synchronization process to be longer than in the case where the macro BS 1b1 is selected as a synchronization-source base station device 1. As a result, the synchronization process is avoided from being performed in vain.

### 5. Fifth Embodiment

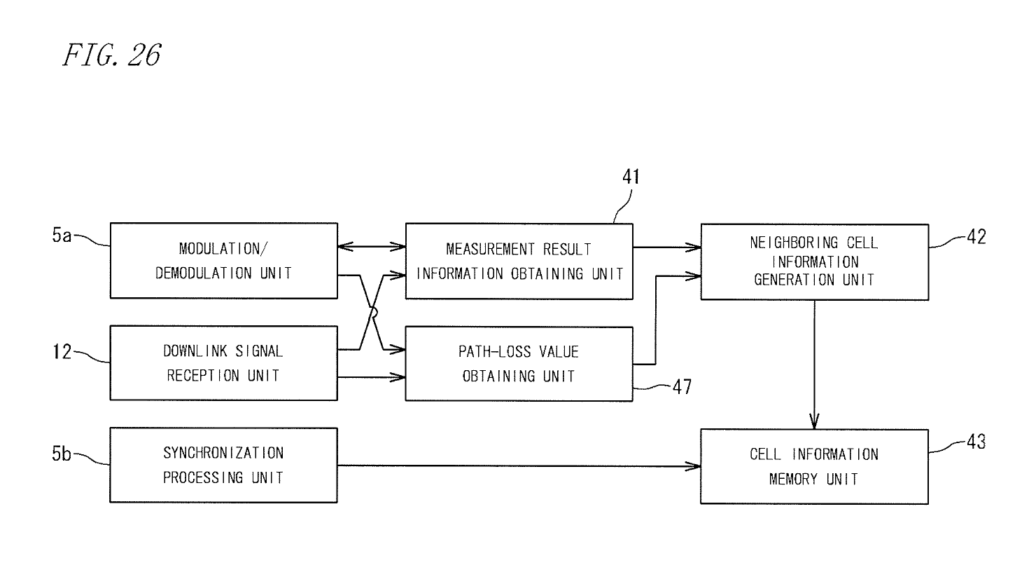

FIG. 26 is a partial block diagram showing a part of an internal configuration of a femto BS 1b according to a fifth embodiment of the present invention. The configuration of a macro BS 1a is substantially the same as that of the femto BS 1b.

The present embodiment is different from the second embodiment in the following points. That is, the femto BS 1b1 includes a path-loss value obtaining unit 47 that obtains a path-loss value between the femto BS 1b1 and another base station device 1. The neighboring cell information generation unit 42 generates and updates neighboring cell information in which the path-loss value is associated with the cell ID of the corresponding base station device 1. The synchronization processing unit 5b adjusts the cycle of the synchronization process in accordance with the path-loss value.

The path-loss value obtaining unit 47 receives a downlink signal received from another base station device 1 by the downlink signal reception unit 12, or a measurement result notification transmitted from an MS 2 connected to the base station device 1b1 that has received the measurement result information, and determines a path-loss value between the base station device 1b1 and the another base station device 1, based on the information included in the downlink signal, or the measurement result notification.

The path-loss value obtaining unit 47 obtains a path-loss value of another base station device 1 as follows. That is, the path-loss value obtaining unit 47 obtains in advance the transmission power of the another base station device 1 from the downlink signal that has been received from the another base station device 1 by the downlink signal reception unit 12, or from the measurement result notification transmitted from the MS 2.

Next, the path-loss value obtaining unit 47 obtains the reception level of the downlink signal of the another base station device 1, from the downlink signal that has been received from the another base station device 1 by the downlink signal reception unit 12, or from the measurement result notification transmitted from the MS 2.

The path-loss value obtaining unit 47 determines a path-loss value from the transmission power and the reception level of the downlink signal of the another base station device 1, which have been obtained as described above.

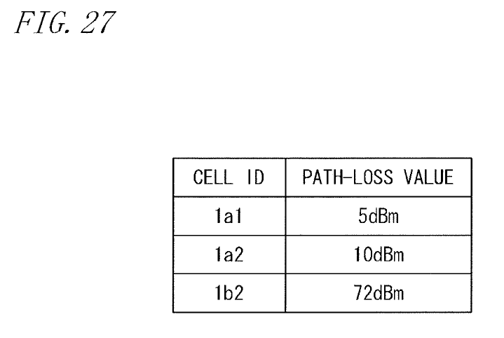

FIG. 27 is a diagram showing an example of neighboring cell information generated by the femto BS 1b1 of the present embodiment.

For example, it is assumed that the path-loss values of the other base station devices 1, which have been determined by the path-loss value obtaining unit 47, are as follows: the path-loss value of the macro BS 1a1 shown in FIG. 13 is 5 dBm, the path-loss value of the macro BS 1a2 is 10 dBm, and the path-loss value of the femto BS 1b2 is 72 dBm. The path-loss value obtaining unit 47 outputs information indicating these path-loss values to the neighboring cell information generation unit 42.

The neighboring cell information generation unit 42 generates neighboring cell information shown in FIG. 27 in which the path-loss values are associated with the corresponding cell IDs.

The synchronization processing unit 5b of the femto BS 1b1 of the present embodiment adjusts the cycle of the synchronization process in accordance with the path-loss value of the synchronization-source base station device 1, as described above.

More specifically, the synchronization processing unit 5b adjusts the cycle of the synchronization process to be shorter if the path-loss value of the synchronization-source base station device 1 is relatively small.

The smaller the path-loss value, the higher the possibility that another base station device 1 corresponding to the path-loss value is located near the base station device 1b1. That is, the path-loss value of another base station device 1 configures information whose value is influenced by the positional relationship between the base station device 1b1 and the another base station device 1.

Further, as described above, the closer the positions of neighboring two base station devices 1 are to each other, the higher the possibility that a downlink signal from one of the two base station devices 1 causes interference to an MS 2 connected to the other base station device 1.

For example, it is assumed that when the neighboring cell information of the femto BS 1b1 is as shown in FIG. 27, the synchronization processing unit 5b of the femto BS 1b1 selects the macro BS 1a1 as a synchronization-source base station device 1. At this time, the path-loss value of the macro BS 1a1 is “5 dBm”, which is smaller than those of the macro BS 1a2 (path-loss value: 10 dBm) and the femto BS 1b2 (path-loss value: 72 dBm). Therefore, the femto BS 1b1 can determine that the macro BS 1a1 is located relatively near the femto BS 1b1 and is most likely to cause interference.

Therefore, the synchronization processing unit 5b adjusts the cycle (timing) of the synchronization process to be shorter than in the case where the macro BS 1b2 or the femto BS 1b2 is selected as a synchronization-source base station device 1. Thereby, the frequency of the synchronization process is relatively increased. As a result, the accuracy of the inter-base-station synchronization is enhanced, and interference that may occur between the femto BS 1b1 and the synchronization-source base station device 1 can be effectively suppressed.

On the other hand, when it is assumed that the synchronization processing unit 5b selects the macro BS 1a2 as a synchronization-source base station device 1, the femto BS 1b1 can determine, based on the reception level, that the macro BS 1a2 is relatively far from the femto BS 1b1, and is less likely to cause interference.

In this case, the necessity of enhancing the accuracy of the inter-base-station synchronization is low, and therefore, the synchronization processing unit 5b adjusts the cycle (timing) of the synchronization process to be longer than in the case where the macro BS 1b1 is selected as a synchronization-source base station device 1. As a result, the synchronization process is avoided from being performed in vain.

As described above, according to the present embodiment, the accuracy of the inter-base-station synchronization can be adjusted according to need, and even when there is a possibility that interference may occur due to the relationship with the synchronization-source base station device 1, the synchronization processing unit 5b can perform the synchronization process so as to favorably avoid such interference.

### 6. Sixth Embodiment

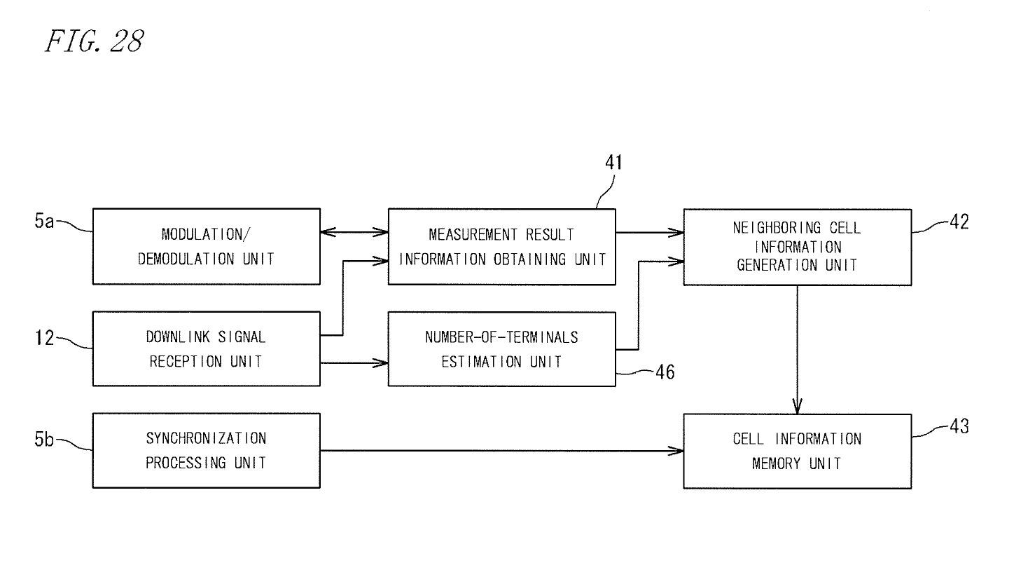

FIG. 28 is a partial block diagram showing a part of an internal configuration of a femto BS 1b according to a sixth embodiment of the present invention. The configuration of a macro BS 1a is substantially the same as that of the femto BS 1b.

The present embodiment is different from the second embodiment in the following points. That is, the femto BS 1b1 includes a number-of-terminals estimation unit 46 that estimates the number of MSs 2 connected to another base station device 1 which is located near the femto BS 1b1. The neighboring cell information generation unit 42 generates and updates neighboring cell information in which the estimated number of terminals is associated with the cell ID of the corresponding base station device 1. The synchronization processing unit 5b adjusts the cycle of the synchronization process in accordance with the estimated number of terminals.

The number-of-terminals estimation unit 46 estimates the number of MSs 2 connected to another base station device 1 located near the base station device 1b1, as follows.

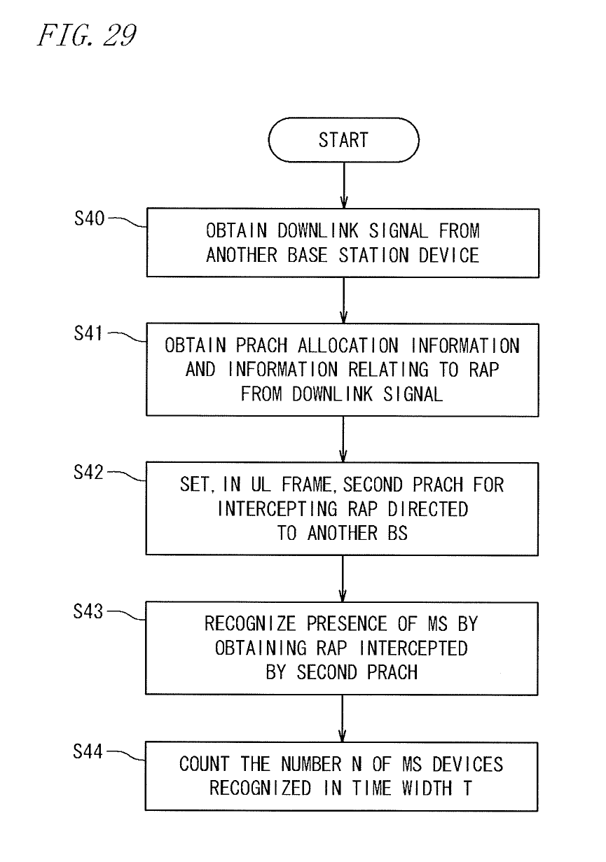

As shown in FIG. 29, the number-of-terminals estimation unit 46 of the femto BS 1b1 firstly obtains a downlink reception signal from the another base station device 1 (step S40). The number-of-terminals estimation unit 46 obtains, from the downlink reception signal, control information required for transmission of a RAP (Random Access Preamble) directed to the another base station device 1, such as allocation information of a PRACH (Physical Random Access Channel) in the another base station device 1, and information relating to the format of the RAP, which are included in the system information of the another base station device 1 (step S41).

Next, based on the PRACH allocation information obtained in step S41, the femto BS 1b1 sets, in its UL frame, a first PRACH for receiving a RAP of an MS 2 that attempts to access the femto BS 1b1, and a second PRACH for intercepting a RAP of an MS 2 that attempts to access the another base station device 1 (step S42).

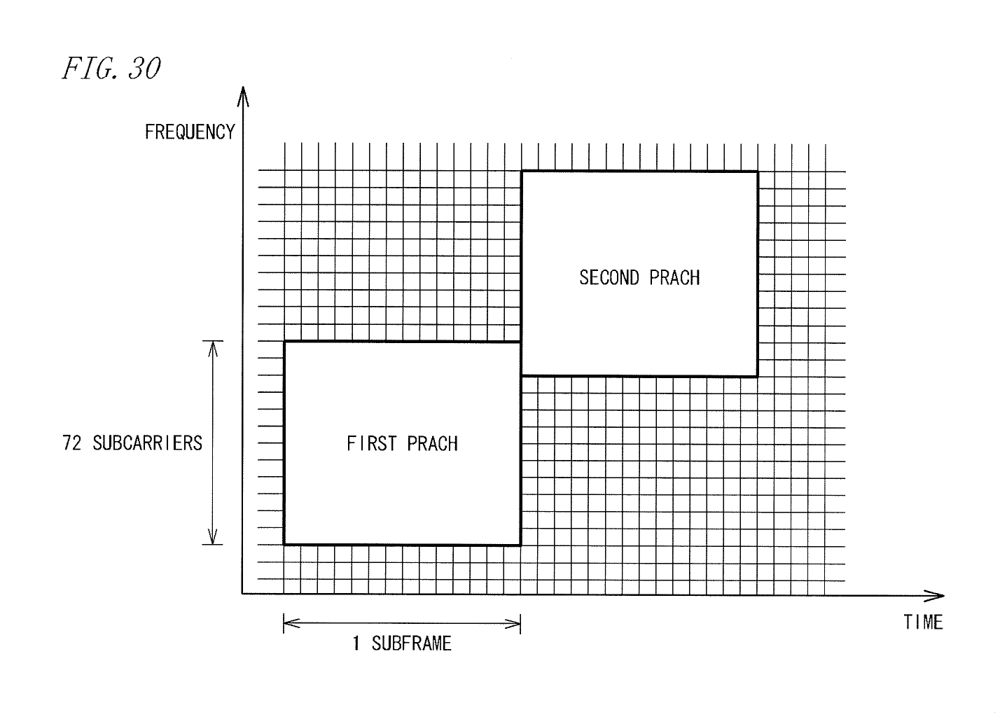

FIG. 30 is a diagram showing an example of a case where the first PRACH and the second PRACH are set on the UL frame. In FIG. 30, each of the first and second PRACHs is set in a range of a band width corresponding to 72 subcarriers in the frequency axis direction, and a range of one subframe width in the time axis direction.

Setting the first and second PRACHs as described above allows the number-of-terminals estimation unit 46 to receive the RAP transmitted by the MS 2 that attempts to access the base station device 1b1, and reliably intercept the RAP transmitted by the MS 2 that attempts to access the another base station device 1.

Referring back to FIG. 29, after setting the second PRACH in step S42, when the number-of-terminals estimation unit 46 intercepts and obtains the RAP transmitted by using the second PRACH, the number-of-terminals estimation unit 46 recognizes that the MS 2 connected to the another base station device 1 exists in the range where the RAP reaches the base station device 1b1 (step S43). At this time, by using the information relating to the format of the RAP obtained in step S41, the number-of-terminals estimation unit 46 can obtain the RAP transmitted to the another base station 1 from the MS 2 connected to the another base station device 1.

Next, the number-of-terminals estimation unit 46 counts the number N of devices of recognized MSs 2 in a range of time width T from the present time back to the past by time T (step S44), and obtains the number N of devices, which is the result of the count, as information indicating the presence of MSs 2 that are located near the base station device 1b1 and connected to the another base station device 1. That is, the number N of devices is regarded as a count value obtained by counting the MSs 2 located in the range in which the RAPs thereof reach the base station device 1b1, as those being located near the base station device 1b1.

The number-of-terminals estimation unit 46 estimates, based on the number N of devices, the number of MSs 2 that are located near the base station device 1b1 and connected to the another base station device 1.

The neighboring cell information generation unit 42 generates neighboring cell information in which the estimated number of MSs 2 is associated with the corresponding cell ID.

The larger the number of MSs that are located near the base station device 1b1 and connected to the another base station device 1, the higher the possibility that the base station device 1b1 interferes with the MSs 2 connected to the another base station device 1.

Therefore, according to the present embodiment, when it is determined, based on the estimated number of MSs connected to the synchronization-source base station device 1, that there is a high possibility that interference may occur, the synchronization processing unit 5b adjusts the cycle of the synchronization process to be shorter so that the frequency of the synchronization process becomes higher than in the case where it is determined that the possibility of occurrence of interference is low. As a result, the accuracy of the inter-base-station synchronization is enhanced, and interference that may occur between the base station device 1b1 and the synchronization-source base station device 1 can be effectively suppressed.

As described above, according to the present embodiment, the accuracy of the inter-base-station synchronization can be adjusted according to need, and even when there is a possibility that interference may occur due to the relationship with the synchronization-source base station device 1, the synchronization processing unit 5b can perform the synchronization process so as to favorably avoid such interference.

### Other Modifications

The second, third, and fifth embodiments illustrate the case where when the base station device 1b1 and the synchronization-source base station device 1 are close to each other to the extent that interference is highly likely to occur, the cycle of the synchronization process is adjusted to be shorter.

In contrast, there are cases where if the base station device 1b1 and another base station device 1 are close to each other and the reception accuracy of a downlink signal from the another base station device 1 is high, inter-base-station synchronization can be achieved with high accuracy by a single synchronization process. Therefore, if the reception accuracy of the downlink signal from the another base station device 1 is high to the extent that allows highly accurate inter-base-station synchronization, the synchronization accuracy can be maintained high without reducing the cycle of the synchronization process. As a result, it is possible to perform the synchronization process so that interference is favorably avoided.

Accordingly, the synchronization processing unit 5b may adjust the timing to perform the synchronization process, based on information indicating the reception accuracy of the downlink signal from the another base station device 1, or information whose value may influence the reception accuracy of the transmission signal from the another base station device.

In this case, for example, if the reception accuracy of the downlink signal from the another base station device 1 as a synchronization source is high to the extent that allows highly accurate inter-base-station synchronization, the cycle of the synchronization process can be adjusted to be relatively longer than in the case where the reception accuracy is lower than the above level.

The synchronization processing unit 5b can use, as the reception accuracy of the downlink signal from the another base station device 1, the reception level or the SINR (Signal-to-Interference and Noise power Ratio).

The closer the synchronization-source base station device 1 is to the base station device 1b1, the higher the reception accuracy of the transmission signal from the synchronization-source base station device 1. That is, the positional relationship between the base station device 1b1 and the synchronization-source base station device 1 influences the reception accuracy of the downlink signal from the synchronization-source base station device 1.

Accordingly, the synchronization processing unit 5b may use, as the information whose value influence the reception accuracy of the downlink signal from the synchronization-source base station device 1, either information indicating the positional relationship between the base station device 1b1 and the synchronization-source base station device 1 or information whose value is influenced by the positional relationship between the base station device 1b1 and the synchronization-source base station device 1.

In this case, the synchronization processing unit 5b adjusts the timing to perform the synchronization process, based on the information indicating the positional relationship between the base station device 1b1 and the synchronization-source base station device 1, or the information whose value is influenced by the positional relationship between the base station device 1b1 and the synchronization-source base station device 1. Accordingly, for example, when it is determined, based on the above-mentioned information, that the base station device 1b1 and the synchronization-source base station device 1 are close to each other and the reception accuracy of the transmission signal from the synchronization-source base station device 1 is high to the extent that allows highly accurate inter-base-station synchronization, the accuracy of the inter-base-station synchronization can be maintained high without increasing the frequency of the synchronization process. Therefore, the timing of the synchronization process can be adjusted so that the frequency of the synchronization process becomes relatively low. As a result, the accuracy of the inter-base-station synchronization can be maintained high without performing the synchronization process in vain, and interference that may occur between the base station device 1b1 and the synchronization-source base station device 1 can be effectively suppressed.

On the other hand, when it is determined, based on the above-mentioned information, that the base station device 1b1 and the synchronization-source base station device 1 are relatively far from each other and the reception accuracy of the transmission signal from the synchronization-source base station device 1 is relatively low, the timing of the synchronization process may be adjusted so that the frequency of the synchronization process becomes higher than in the case where it is determined that the reception accuracy is high. As a result, the accuracy of the inter-base-station synchronization is enhanced, and interference that may occur between the base station device 1b1 and the synchronization-source base station device 1 can be effectively suppressed.

As described above, according to the femto BS 1b1, it is possible to perform the synchronization process so that interference is favorably avoided, by adjusting the timing at which the synchronization process is performed, based on such as the information indicating the positional relationship between the base station device 1b1 and the synchronization-source base station device 1, which is information that influences the reception accuracy of the transmission signal from the synchronization-source base station device 1.

Note that the positional relationship in which the base station device 1b1 and the synchronization-source base station device 1 are close to each other enough to determine that the reception accuracy of the transmission signal from the synchronization-source base station device 1 is high to the extent that allows highly accurate inter-base-station synchronization, is for example, a positional relationship in which the cell of the base station device 1b1 is located very close to the synchronization-source base station device 1. That is, a range that is defined by the positional relationship between the base station device 1b1 and the synchronization-source base station device 1 when it is determined that the reception accuracy of the transmission signal from the synchronization-source base station device 1 is high, is included in a range that is defined by the positional relationship between the base station device 1b1 and the synchronization-source base station device 1 when it is determined that the possibility of occurrence of interference is high.

Accordingly, if the base station device 1b1 and the synchronization-source base station device 1 are away from each other with respect to their positional relationship by which it is determined that the reception accuracy of the transmission signal from the synchronization-source base station device 1 is high, these base station devices are in the positional relationship by which it is determined that the possibility of occurrence of interference between these base station devices is high, although the reception accuracy of the transmission signal from the synchronization-source base station device 1 cannot be obtained to the extent that allows highly accurate inter-base-station synchronization. In this case, the femto BS 1b1 adjusts the cycle of the synchronization process to be shorter so as to effectively suppress interference, thereby enhancing the accuracy of the inter-base-station synchronization.

Specifically, the information whose value is influenced by the positional relationship between the base station device 1b1 and the synchronization-source base station device 1 is information relating to the detection result obtained when the transmission signal of the synchronization-source base station device 1 is detected. More specifically, the information relating to the detection result obtained when the transmission signal of the synchronization-source base station device 1 is detected is, preferably, the number of times the synchronization-source base station device 1 is detected within a predetermined period, or the detection rate that is a ratio of the number of times the synchronization-base station device 1 is detected, to the number of times the detection is executed.

Further, the information relating to the detection result obtained when the transmission signal of the synchronization-source base station device 1 is detected may be the time at which the transmission signal from the synchronization-source base station device 1 has been detected most recently, or the elapsed time from that time to the present time.

Further, the information whose value is influenced by the positional relationship between the base station device 1b1 and the synchronization-source base station device 1 may be information relating to the number of trials of handover of a terminal device connected to the synchronization-source base station device 1, which is performed between the base station device 1b1 and the synchronization-source base station device 1, or information whose value is influenced by the number of trials of handover.

The reason is as follows. That is, each of the respective pieces of information described above is information whose value is influenced by the positional relationship between the base station device 1b1 and the synchronization-source base station device 1, as described for the respective embodiments above.

As described above in detail, the femto BS 1b1 of the present embodiment is provided with the synchronization processing unit 5b that adjusts the timing to perform synchronization process, based on the information indicating whether interference can occur due to the relationship between the base station device 1b1 and the synchronization-source base station device 1. Therefore, when it is determined that interference can occur due to the relationship with the another base station device, the frequency of the synchronization process can be increased to effectively suppress such interference, and thus the accuracy of the inter-base-station synchronization can be enhanced. As a result, even when there is a possibility that interference may occur due to the relationship with the synchronization-source base station device 1, it is possible to perform the synchronization process so that such interference is favorably avoided.

The synchronization processing unit 5b may use the number of terminal devices connected to its own base station device and/or another base station device, as the information indicating whether interference can occur due to the relationship between the base station device 1b1 and the synchronization-source base station device 1.

Further, as the information indicating whether interference can occur due to the relationship between the base station device 1b1 and the synchronization-source base station device 1, the synchronization processing unit 5b may use: information indicating the carrier wave frequency of the synchronization-source base station device 1; information that allows identification as to whether the synchronization-source base station device 1 is a macro base station or a femto base station; information indicating the transmission power of the downlink signal from the synchronization-source base station device 1; information indicating the access mode of the synchronization-source base station device 1 to an MS 2 connected to the synchronization-source base station device 1; or the estimated number of MSs 2 that are located near the base station device 1b1 and are connected to the synchronization-source base station device 1.

The closer the synchronization-source base station device 1 is to the base station device 1b1, the higher the possibility that the downlink signals from the base station device 1b1 and the synchronization-source base station device 1 interfere with the MSs 2 connected to these base station devices, respectively. Thus, depending on the positional relationship between the base station device 1b1 and the synchronization-source base station device 1, it is preferable that the accuracy of the inter-base-station synchronization between these base station devices is high in order to effectively suppress such interference.

Accordingly, the information indicating whether interference can occur due to the relationship between the base station device 1b1 and the synchronization-source base station device 1 is, preferably, information indicating the positional relationship between the base station device 1b1 and the synchronization-source base station device 1, or information whose value is influenced by the positional relationship between the base station device 1b1 and the synchronization-source base station device 1.

In this case, the synchronization processing unit 5b adjusts the timing to perform the synchronization process, based on the information indicating the positional relationship between the base station device 1b1 and the synchronization-source base station device 1, or the information whose value is influenced by the positional relationship between the base station device 1b1 and the synchronization-source base station device 1. Accordingly, for example, when it is determined, based on the above-mentioned information, that the base station device 1b1 and the synchronization-source base station device 1 are relatively close to each other and the possibility that interference may occur is high, the synchronization processing unit 5b can adjust the timing of the synchronization process so as to increase the frequency of the synchronization process. As a result, the accuracy of the inter-base-station synchronization is enhanced, and interference that may occur between the base station device 1b1 and the synchronization-source base station device 1 can be effectively suppressed.

On the other hand, when it is determined, based on the above-mentioned information, that the base station device 1b1 and the synchronization-source base station device 1 are relatively far from each other and the possibility that interference may occur is low, the synchronization processing unit 5b can adjust the timing of the synchronization process so that the frequency of the synchronization process becomes lower than in the case where the possibility that interference may occur is high. As a result, the synchronization process is avoided from being performed in vain.

As described above, according to the femto BS 1b1, since the timing at which the synchronization process is performed is adjusted based on such as the information indicating the positional relationship between the base station device 1b1 and the synchronization-source base station device 1, even when there is a possibility that interference can occur due to the relationship with the synchronization-source base station device 1 in the inter-base-station synchronization, it is possible to perform the synchronization process so as to favorably avoid such interference.

The synchronization processing unit 5b may use positional information obtained by the GPS function, as the information indicating the positional relationship between the base station device 1b1 and the synchronization-source base station device 1.

Further, as the information whose value is influenced by the positional relationship between the base station device 1b1 and the synchronization-source base station device 1, the synchronization processing unit 5b may use: information relating to the detection result obtained when the transmission signal from the synchronization-source base station device 1 is detected; the reception level of the transmission signal from the synchronization-source base station device 1; or the path-loss value between the synchronization-source base station device 1 and the base station device 1b1.

As the information relating to the detection result obtained when the transmission signal of the synchronization-source base station device 1 is detected, the synchronization processing unit 5b may use: the number of times the synchronization-source base station device 1 is detected within a predetermined period; the detection rate that is a ratio of the number of times the synchronization-source base station device 1 is detected, to the number of times the detection is executed; the time (last detection time) at which the downlink signal from the synchronization-source base station device 1 has been detected most recently; or the elapsed time from the last detection time to the present time.

Further, as the information whose value is influenced by the positional relationship between the base station device 1b1 and the synchronization-source base station device 1, the synchronization processing unit 5b may use the number of trials of handover of an MS 2, which is performed between the base station device 1b1 and the another base station device 1, or information whose value is influenced by the number of trials of handover.

Further, as the information whose value is influenced by the number of trials of handover, the synchronization processing unit 5b may use the number of successes of handover, and the handover success rate, which are determined based on the number of trials of handover.

Further, the synchronization processing unit 5b may adjust the timing to perform the synchronization process, based on not only the information indicating whether interference can occur due to the relationship between the base station device 1b1 and the synchronization-source base station device 1 but also information indicating whether the interference is avoidable. In this case, it is possible to favorably avoid interference between the base station device 1b1 and the synchronization-source base station device 1 that is likely to cause interference.

More specifically, the information indicating whether the interference is avoidable is, preferably, information indicating a resource block allocation scheme adopted when the synchronization-source base station device 1 performs resource allocation to MSs 2 connected to the synchronization-source base station device 1, or information indicating whether inter-base-station communication via the X2 interface is possible between the base station device 1b1 and the synchronization-source base station device 1.

Further, the synchronization processing unit 5b may adjust the timing to perform the synchronization process, based on information indicating the reception accuracy of the downlink signal from the synchronization-source base station device 1, or information whose value influences the reception accuracy of the transmission signal from the another base station device. In this case, if the reception accuracy of the downlink signal from the synchronization-source base station device 1 is high to the extent that allows highly precise inter-base-station synchronization, the synchronization accuracy can be maintained high without increasing the frequency of the synchronization process. As a result, it is possible to perform the synchronization process so as to favorably avoid interference.

The information indicating the reception accuracy of the downlink signal from the synchronization-source base station device 1 is preferably the reception level at which the downlink signal is received, or the SINR.

Further, as the information whose value influences the reception accuracy of the transmission signal from the synchronization-source base station device 1, the synchronization processing unit 5b may use information indicating the positional relationship between the base station device 1b1 and the synchronization-source base station device 1, or information whose value is influenced by the positional relationship between the base station device 1b1 and the synchronization-source base station device 1.

As the information whose value is influenced by the positional relationship between the base station device 1b1 and the synchronization-source base station device 1, the synchronization processing unit 5b may use information relating to the detection result obtained when the transmission signal from the synchronization-source base station device 1 is detected. More specifically, the synchronization processing unit 5b may use: the number of times the synchronization-source base station device 1 is detected within a predetermined period; the detection rate that is a radio of the number of times the synchronization-source base station device 1 is detected, to the number of times the detection is executed; the time at which the transmission signal from the synchronization-source base station device 1 has been detected most recently; or the elapsed time from that time to the present time.

Further, as the information whose value is influenced by the positional relationship between the base station device 1b1 and the synchronization-source base station device 1, the synchronization processing unit 5b may use information relating to the numbers of trials of handover of MSs 2 connected to the base station device 1b1 and the synchronization-source base station device 1, which are performed between the base station device 1b1 and the synchronization-source base station device 1, or information whose value is influenced by the numbers of trials of handover.

Note that the embodiments disclosed are to be considered in all respects as illustrative and not restrictive. The scope of the invention is indicated by the appended claims rather than by the foregoing meaning, and all changes which come within the meaning and range of equivalency of the claims are therefore intended to be embraced therein.

1. A base station device comprising:
a reception unit that receives a transmission signal from another base station device;
a processing unit that obtains the transmission signal from the reception unit, and performs a process with respect to the transmission signal; and
a detection unit that detects the number of terminal devices connected to the base station device and/or the another base station device, wherein
the processing unit adjusts the timing to obtain the transmission signal, based on the number of terminal devices connected to the base station device and/or the another base station device.

2. The base station device according to claim 1, wherein the processing unit adjusts the timing so that the process is periodically performed, and adjusts the cycle of the process based on the number of terminal devices connected to the base station device and/or the another base station device.

3. The base station device according to claim 1, wherein the detection unit measures a reception power of the transmission signal received from the another base station device, and detects, based on the reception power, the number of terminal devices connected to the base station device and/or the another base station device.

4. The base station device according to claim 3, wherein the detection unit measures the reception power of the downlink signal from the another base station device, for each of minimum units of resource allocation in the downlink signal from the another base station device.

5. (canceled)

6. The base station device according to claim 1, wherein the processing unit includes a synchronization processing unit that performs a synchronization process for achieving inter-base-station synchronization with the another base station device, based on the transmission signal.

7. The base station device according to claim 6, wherein the synchronization processing unit adjusts the cycle of the synchronization process to be longer as the number of terminal devices connected to the base station device decreases.

8. The base station device according to claim 6, wherein the synchronization processing unit adjusts the cycle of the synchronization process to be longer as the number of terminal devices connected to the another base station device decreases.

9. The base station device according to claim 1, wherein the processing unit includes a measurement processing unit that performs a measurement process for measuring the transmission signal.

10. The base station device according to claim 9, wherein the detection unit detects the number of terminal devices connected to the base station device and/or the another base station device, by using a measurement result by the measurement processing unit.

11. A base station device comprising:
a reception unit that receives a transmission signal from another base station device; and
a processing unit that obtains the transmission signal from the reception unit, and performs, based on the transmission signal, a synchronization process for achieving inter-base-station synchronization, wherein
the processing unit adjusts the timing to perform the synchronization process, based on information indicating whether interference can occur due to the relationship between the base station device and the another base station device.

12. The base station device according to claim 11, wherein the information indicating whether interference can occur due to the relationship between the base station device and the another base station device is the number of terminal devices connected to the base station device and/or the another base station device.

13. The base station device according to claim 11, wherein the information indicating whether interference can occur due to the relationship between the base station device and the another base station device is information indicating the positional relationship between the base station device and the another base station device, or information whose value is influenced by the positional relationship between the base station device and the another base station device.

14. The base station device according to claim 13, wherein the information whose value is influenced by the positional relationship between the base station device and the another base station device is information relating to a detection result obtained when a transmission signal from the another base station device is detected, or a reception level of the transmission signal from the another base station device, or a path-loss value between the base station device and the another base station device.

15. The base station device according to claim 14, wherein the information relating to a detection result obtained when a transmission signal from the another base station device is detected is the number of times the another base station device is detected within a predetermined time period, or a detection rate that is a ratio of the number of times the another base station device is detected, to the number of times the detection is executed.

16. The base station device according to claim 14, wherein the information relating to a detection result obtained when a transmission signal from the another base station device is detected is the time at which the transmission signal from the another base station device has been detected most recently, or the elapsed time from the time at which the downlink signal from the another base station device has been detected most recently to the present time.

17. The base station device according to claim 13, wherein the information whose value is influenced by the positional relationship between the base station device and the another base station device is information relating to the number of trials of handover by a terminal device connected to the base station device or the another base station device, the handover being performed between the base station device and the another base station device, or information whose value is influenced by the number of trials of handover.

18. The base station device according to claim 11, wherein the information indicating whether interference can occur due to the relationship between the base station device and the another base station device is information indicating a carrier wave frequency of the another base station device, information that allows identification as to whether the another base station device is a macro base station or a femto base station, information indicating a transmission power of the transmission signal, information indicating an access mode of the another base station device to a terminal device connected to the another base station device, or the estimated number of terminal devices that are located near the base station device and are connected to the another base station device.

19. The base station device according to claim 11, wherein the processing unit adjusts the timing to perform the synchronization process, based on, in addition to the information indicating whether interference can occur due to the relationship between the base station device and the another base station device, information indicating whether the interference is avoidable.

20. The base station device according to claim 19, wherein the information indicating whether the interference is avoidable is information indicating a resource block allocation scheme adopted when the another base station device performs resource allocation to the terminal device connected to the another base station device, or information indicating whether inter-base-station communication is possible between the base station device and the another base station device.

21. A base station device comprising:
a reception unit that receives a transmission signal from another base station device; and
a processing unit that obtains the transmission signal from the reception unit, and performs, based on the transmission signal, a synchronization process for achieving inter-base-station synchronization, wherein
the processing unit adjusts the timing to perform the synchronization process, based on information indicating a reception accuracy of a transmission signal from the another base station device, or information whose value influences the reception accuracy of the transmission signal from the another base station device.

22. The base station device according to claim 21, wherein the information indicating a reception accuracy of a transmission signal from the another base station device is a reception level at which the transmission signal is received, or an SINR.

23. The base station device according to claim 21, wherein the information whose value influences the reception accuracy of a transmission signal from the another base station device is information indicating the positional relationship between the base station device and the another base station device, or information whose value is influenced by the positional relationship between the base station device and the another base station device.

24. The base station device according to claim 23, wherein the information whose value is influenced by the positional relationship between the base station device and the another base station device is information relating to a detection result obtained when the transmission signal from the another base station device is detected.

25. The base station device according to claim 24, wherein the information relating to a detection result obtained when the transmission signal from the another base station device is detected is the number of times the another base station device is detected within a predetermined period, or a detection rate that is a ratio of the number of times the another base station device is detected, to the number of times the detection is executed.

26. The base station device according to claim 24, wherein the information relating to a detection result obtained when the transmission signal from the another base station device is detected is the time at which the transmission signal from the another base station device has been detected most recently, or the elapsed time from the time at which the downlink signal from the another base station device has been detected most recently to the present time.

27. The base station device according to claim 23, wherein the information whose value is influenced by the positional relationship between the base station device and the another base station device is information relating to the number of trials of handover by a terminal device connected to the base station device or the another base station device, the handover being performed between the base station device and the another base station device, or information whose value is influenced by the number of trials of handover.

28. A base station device comprising:
a reception unit that receives a transmission signal from another base station device; and
a processing unit that obtains the transmission signal from the reception unit, and performs a process with respect to the transmission signal, wherein
the processing unit adjusts the timing to obtain the transmission signal, based on the number of terminal devices connected to the base station device and/or the another base station device.
